(19) United States
(12) Patent Application Publication
(10) Pub. No.: US 2006/0265418 A1
(43) Pub. Date: Nov. 23, 2006

(54) System, program product, and methods for managing events

(75) Inventors: Carl T. Dolezal, Dickinson, TX (US); Scott M. Hermstein, League City, TX (US); Ben G. Raimer, Galveston, TX (US); David K. Rassin, Galveston, TX (US)

Correspondence Address: BRACEWELL & GIULIANI LLP, P.O. BOX 61389, HOUSTON, TX, 77208-1389, US

(73) Assignee: Board of Regents, The University of Texas System

(21) Appl. No.: 11/430,408

(22) Filed: May 9, 2006

Related U.S. Application Data
(60) Provisional application No. 60/683,594, filed on May 23, 2005.

(51) Int. Cl. G06F 7/00

(52) U.S. Cl. 707/102

(57) ABSTRACT

A system to facilitate event registration, planning, promotion, and management of events through an on-line event management website over a computer network, program product, and associated methods are provided. The system includes an event management server, a database accessible to the event management server and including user data records and event data records, a plurality of event management member user's computers to provide event management member users with on-line web-based access over the computer network to the data records, and a plurality of potential event attendee user's computers to provide potential event attendee users with on-line web-based access to the data records. The system also includes an event management program product stored in the memory of the event management server to provide each of the event management member users concurrent access to data records over the computer network to manage event planning and delivery, and to provide the potential event attendee users concurrent access to the data records over the computer network to self-register for the events and to manage continuing education requirements.

### RELATED APPLICATIONS

This application is related to and claims priority to and the benefit of U.S. Provisional Application No. 60/683,594, filed on May 23, 2005, incorporated herein by reference in its entirety.

### BACKGROUND OF THE INVENTION

1. Field of the Invention

The present invention relates in general to event management systems and, in particular, a system, program product, and methods of facilitating event registration, planning, creation, promotion, and management of events through an on-line event management website.

2. Description of Related Art

Continuing education is a fundamental requirement for many professionals and technical specialists such as, for example, physicians of various specialties, other health care providers, attorneys, professional engineers, and others just to name a few. Continuing education allows the professional or technical specialist to keep abreast of current technology and current knowledge in order for the professional or technical specialist to advance their skills to thereby provide enhanced service. The continuing education process can encompass all the areas usually encountered by the professional or technical specialist necessary to carry out their professional or technical services.

In many cases, the state and/or professional organizations related to the individual's profession for specialty provides mandatory requirements on the professional or technical specialist to obtain a minimum number of units or credit hours within a predetermined time period. The various accrediting agencies authorize a plethora of private and public organizations to serve as providers of such continuing education. These continuing education provider organizations have traditionally hosted events in the form of seminars. The seminars are typically traditional classroom or auditorium training sessions, but recent development of improved computer networks has resulted in the emergence of on-line continuing education courses. The traditional seminars or events are typically offered in different cities and at different times throughout the year. The traditional events, however, require extensive organization and planning by individual event coordinators.

Organizations requiring event planning, administration, and registration such as, for example, continuing education provider organizations, also often face extensive overhead due to the inherent difficulties in event management. Regardless of the organizational structure, multiple events are typically planned and implemented by the organization at different locations often during overlapping time periods. Event coordinators typically maintain event planning data in various custom formats. Further, the event planning data is typically located remote from and often inaccessible to other event coordinators and other event management staff members.

This lack of standardization and accessibility can cause difficulty for other members tasked with delivering event information to access, organize, and further help promote current information about the planned events. For example, it is generally not until an event is finally planned that the event coordinator provides other event management staff members a final version of the event description, date or dates of the event, hotel accommodations, meal accommodations, pricing information for the event, hotel, and meals, available seats, and other event attributes. This event information, frequently provided in varying file formats, is then formatted for various internal reports to allow for supervisory oversight and formatted for reports specifically for review by the event sponsor or sponsors and/or event director. This report generation extracts a significant amount of resources in order to provide what is invariably the same or similar information. Thus, the Applicants have recognized the need for an event management system that allows event management staff, event directors, event coordinators, and event sponsors to access and view custom event reports.

Further, the event information, often delivered relatively very late, is normally needed long before the event start date in order to finalize the creation of brochures, web page advertisements, registration forms, and to access other advertising media. The event management staff members typically need lead-time to construct or have constructed an advertising web page prior to performing mass mailing of flyers or mass e-mailing through proprietary and purchased e-mail lists. The lead-time is required because construction of the advertising web page is normally accomplished using web page development tools or external web page development services. Correspondingly, event planning must be completed earlier than would otherwise be necessary or notification and advertisement of the events may be conducted without sufficient time to reach all of the intended audience prior to the deadline for registering for the event. Thus, the Applicants have recognized the need for a web-friendly event management system which provides easy entry of new events without the need for custom programming resources.

Depending upon the type of event being provided, the potential event attendees or customers are often busy professionals or technical specialists that must have sufficient advance notice to plan to attend an event, especially if the event is not held in the attendee's local area. These busy professionals or technical specialists will not typically spend much time continually searching for updated events. The Applicants have thus recognized the need to provide automated e-mail notification services to those potential attendees that indicate they wish to be notified of new events. The Applicants have also recognized the need for a website providing a central location for potential attendees to easily check for and/or review all additional new events. The Applicants have further recognized the need for providing both on-line registration and payment, to not only reduce overhead costs, but also to encourage the potential attendee to register for an event prior to leaving the website.

Due to an increase in the proliferation of inexpensive mass media options, event management organizations are faced with growing competition for potential attendees, and thus, the need for a more proactive event management system. This includes a need to provide additional services. For continuing education provider organizations, for example, most potential attendees have been found to be busy professionals or technical specialists that typically lack the time or the resources to easily track continuing education, e.g., dates of attendance, number of units or credits earned, and attendance documentation. This typically results in poor continuing education management, making what would be a desirable opportunity to break routine while attending an event designed to expand the professional's or technical specialist's knowledge base, into an undesirable schedule interruption. That is, failure to properly track the number of credits earned or loss or misplacement of attendance documentation can result in the busy professional being required to attend additional or last-minute continuing education events at unplanned and possibly inopportune time periods in order to meet a time sensitive regulatory requirement.

The continuing education requirements are different for the different types of professions, and can be different for each specialty within a particular profession. For example, the American Medical Association requires a different number of credits than the American Academy of Family Physicians. Thus, the Applicants have recognized the need for an event management system that allows continuing education staff members to easily obtain and manage information relating to conveyance of continuing education credits, that allows attendees to view credits earned and that allows attendees to retrieve earned continuing education credit documentation. The Applicants have also recognized the need for an event management system that provides the ability to track continuing education compliance regardless of the type of professional or technical specialist earning the continuing education credits.

### SUMMARY OF THE INVENTION

In view of the foregoing, embodiments of the present invention advantageously provide an on-line event management system, program product, and related methods that allow event management staff members, event directors, event coordinators, event sponsors, and other stakeholders including lodging facilities, caterers, and others needing to know data related to event registrants, to access and view custom event reports, and that provide a central location, e.g., web page, for potential attendees to easily check for and/or review all additional new events. Advantageously, the event management system provides selective information for multiple users depending upon the classification and/or status of the user. Advantageously, embodiments of the present invention provide a web-friendly event management system which provides easy entry of new events without the need for custom programming resources to allow individual event management organizations to plan and edit events and automatically generate on-line event registration forms.

Advantageously, embodiments of the present invention provide a website which provides for both on-line event of registration and on-line payment for a selected event, to advantageously not only encourage potential attendees to register for an event prior to leaving the website, but to ultimately reduce overhead event management costs by reducing the need for registrants to directly contact event management member personnel in order to register for an event. Embodiments of the present invention can provide automated e-mail notification services to those potential attendees that indicate they wish to be notified of new events. Advantageously, embodiments of the present invention allow event management member personnel to easily obtain and manage information relating to conveyance of continuing education credits, track continuing education credits regardless of the type or category of professional or specialist earning such continuing education, and that allows attendees to view credits earned and retrieve earned credit documentation associated with an attended event.

More specifically, embodiments of the present invention include an event management system, program product, and related methods that facilitate event registration, planning, promotion, and management of events through an on-line event management website over a computer network. For example, according to an embodiment of the present invention, a system to facilitate event registration, planning, promotion, and management of continuing education events, e.g., continuing medical education events, includes at least one host computer hosting the online event management website accessible to the computer network to define an event management server. The event management server has a processor and memory coupled to the processor to store operating instructions therein. A database accessible to the processor of the event management server includes user data records and event data records related to a plurality of preferably accredited continuing education events. The user data records include user attribute data, such as, for example, a user name and password, proper name, preferred name, title, ADA requirements, willingness to receive e-mail updates regarding future events, professional affiliation, educational degrees received, professional specialties, and professional licenses, which can be used to market the various events. The event data records can include event attribute data such as, for example, an event time, event location, event description, and event sponsor for each of the plurality of continuing education events.

Embodiments of a system also can include a plurality of event management member user's computers each positioned remote from the event management server and accessible to the computer network. Each event management member user's computer has a processor, memory coupled to the processor to store operating instructions therein and to receive database records, a display in communication with the processor to display data records using an associated event management member user's web browser, and a user interface in communication with the processor, to provide each of a corresponding plurality of event management member users with on-line web-based access to the event data records over the communication network. Advantageously, this allows each event management member user to view and edit event data over the network using a standard web browser. Further, at least one of the event management member user's computers is preferably an event coordinator user computer assigned primary responsibility for one or more of the events. The web-based implementation allows the event coordinator through the event coordinator user computer to provide event planning updates to all interested event management member users, anywhere the event coordinator can access the web.

Embodiments of a system further can include a plurality of potential attendee user's computers each positioned at a respective plurality of potential attendee user sites remote from the event management server and accessible to the computer network. Each potential attendee user's computer has a processor and memory coupled to the processor to store operating instructions therein and to receive database records, a display in communication with the processor to display data records using an associated potential attendee user's web browser, and a user interface in communication with the processor to provide the potential attendee user with on-line web-based access to user data records over the computer network. Advantageously, this allows each potential attendee user to view and edit the respective user's user data and to access event data records over the computer network to thereby view event data to register for scheduled events.

Also, because embodiments of a system are advantageously web-based, such embodiments can easily deliver event data to external users individually tailored to the specific needs of the external users according to the user's classification. For example, event directors may need specific demographic details about each event registrant, whereas event sponsors, e.g., an event pharmaceutical representative, may only need (or be authorized) a high-level head count and number of specialists attending and thus, need not be provided such details about each event registrant, provided to, for example, the event directors.

Embodiments of a system according to the present invention can also include an event sponsor user's computer positioned at an event sponsor user site remote from the event management server and accessible to the computer network to provide an event sponsor user with on-line web-based access to event data records over the computer network generally in the form of preformatted reports. Advantageously the respective event's sponsor can review, real-time, event data such as, for example, event registration and attendance levels for an event. The system can also include an event director user's computer positioned at an event directory user site remote from the event management server and accessible to the computer network to also provide the event director user with on-line web-based access to event data records over the computer network also generally in the form of preformatted reports.

Embodiments of a system still can further include an event management program product stored in the memory of the event management server to facilitate event registration, planning, and management of continuing education events over the computer network. Advantageously, according to embodiments of the present invention, the event management program product is a web-based program that provides web-based functionality. Accordingly, beyond the installation of a common web browser, specialized software installation is not necessary. Also because embodiments of the event management program product is web-based, such program product is portable to multiple computer systems, and is easily accessible by multiple concurrent users at a single time through web access, providing a single focal location for substantially all event information.

In an embodiment of the present invention, the event management program product includes various functional components: An event planner is positioned to provide to a plurality of event management member user's web browsers a new-event-creation web page form having a plurality of database input fields, and is positioned to perform, responsive to data entered by a corresponding plurality of event management member users, the operations of initializing new events, receiving new event data, adding new event data records to the database, and editing pending new event data records previously stored in the database. A people manager is positioned to provide to a plurality of potential attendee user's web browsers event management website registration web page forms having a plurality of potential attendee user attribute data fields, and is positioned to perform, responsive to data entered by the potential attendee users, the operation of storing in the database user data records including the user attribute data for each potential attendee user.

An event registrar is positioned to access the user data records and the event data records in the database, is positioned to provide to potential attendee user's web browsers an event registration web page form to register for a user selected event, and is positioned to perform, responsive to initiating registration for a selected event, the operation of associating potential attendee users to the selected events. The event register can also perform the operation of providing an e-commerce web page form to the potential attendee users through each respective potential attendee user's web browser, to provide each potential attendee user real-time self-registrations, and to provide each potential attendee user on-line payment options including on-line check and on-line credit card payment options. Advantageously, by providing the e-commerce web page form, the event coordinator user for the respective event is provided with substantially real-time registration data to enhance event planning and evaluation.

An entry initiator is positioned to access the user data records in the database to thereby provide user login access for and authentication of each user to allow entry of and access to data stored in the database. An administrator is positioned to access the user data records in the database to thereby determine user permission levels and to restrict access to data in the database. An event information reporter is positioned to access the event data records in the database to thereby produce reports related to events selected by a user, such as, for example, an event management member user, the event sponsor, or event director. Advantageously, the reports are formatted to be viewed over the network by the respective user's web browser.

In another embodiment of the present invention, the event management program product includes a set of machine-readable instructions stored in the memory of the event management server to facilitate event registration, planning, and management of events over the computer network. For example, the event management program product includes instructions to perform the operations of: providing each of the plurality of event management member users over the computer network concurrent access to event data records for a plurality of events through each event management member user's web browser; and creating an on-line event registration web page form for each event for registering users to the events. Correspondingly, embodiments of the present invention allow users, e.g., physicians, nurses, and other professionals, to conveniently self-register for scheduled continuing education events or activities on-line, using the on-line event registration web page form. Advantageously, embodiments of the present invention also provide functionality to prevent incidents of duplicate event registrations, thereby improving customer satisfaction. Still further, advantageously the event management program product also includes instructions to perform the operations of providing over the computer network, through each respective user's web browser, to event management member users, event director users, and event sponsor users custom web-based reports indicating, for example, attendee registration or attendance rates for each selected event.

Embodiments of an event management program product according to the present invention can further include instructions to perform the operations of: providing to each of the plurality of potential event attendee user's web browsers a continuing education entry web page form to allow entry of past continuing education event record data, and storing record data entered in the continuing education entry web page form in a continuing education event history record, to thereby provide a continuing education event history data record repository for each of the plurality of potential event attendee users. The instructions can also include those to perform the operations of receiving from each potential event attendee user a completed on-line event registration web page form for at least one event, and adding continuing education event record data to the continuing education event history data record for each respective potential event attendee user, responsive to confirmation of completion of the at least one event. Correspondingly, advantageously, potential attendee users, using their web browsers, can view and print their continuing education credits, certificates, and activities, and can receive automatic notifications of upcoming events.

Embodiments of the present invention also include methods of facilitating event registration, planning, promotion, and management of events through an on-line event management website over a computer network. For example, according to an embodiment of the present invention, a method includes the step of presenting to an event management member user's web browser over the computer network a new-event-creation form to form and plan a new event. The new-event-creation form has a plurality of planning event data fields including, for example, event time, event location, event description, and number of education credits assigned to the new event. The method also includes entering event data for the new event in the new-event-creation form, receiving a completed new-event-creation form for the new event from the event management member's web browser over the computer network, and storing the new event in a database accessible through the on-line event management website.

Embodiments of a method also include review and approval of the new event by an event management member user, e.g., event coordinator, prior to allowing release of the event for event registration. The method also includes releasing the new event by an event management member user, e.g. event administrator, to allow event registration for the new event by a plurality of potential attendees, and creating an on-line event registration web page form, responsive to entry and release of the new event. The on-line event registration web page form preferably includes a plurality of registration event data fields corresponding to the planning event data fields associated with the new-event-creation form. If the event is a continuing education event, the registration event data fields in the on-line event registration web page form preferably include user selectable event attendance and education credit options to thereby provide custom registration for each of the plurality of potential attendee users.

Embodiments of a method can still further include the steps of: adding the new event to a consolidated event listing web page, also responsive to release of the new event by the event management member user, to thereby display the new event to the plurality of potential attendee users; presenting to each potential attendee user's web browser over the computer network the consolidated event listing web page displaying the new event; and presenting to each potential attendee user's web browser over the computer network the on-line event registration web page form, responsive to selection of the new event on the consolidated event listing web page by each respective potential attendee user.

Advantageously, in order to enhance the registration process and to obtain user data useful in marketing events to potential attendee users, the method can include presenting to each of the plurality of potential attendee users an event management website registration web page form including a plurality of potential attendee user attribute fields to pre-register each potential attendee user with the on-line event management website, to thereby enhance event registration. Some of the potential attendee attributes can include, for example, potential attendee user location, potential attendee user specialty, and potential attendee user classification.

Embodiments of a method also include providing selective marketing of a plurality of events, responsive to the potential attendee attributes provided by the potential attendee user in the event management website registration web page form, to thereby enhance event marketing and event attendance. Selective marketing can also be provided in response to marketing assessment data collected from the potential attendee user to be used to assess marketing effort effectiveness and to identify optimal marketing channels. Such data can be collected in the on-line event registration web page form by providing to the potential attendee user request text and/or a request field in the on-line event registration web page form to provide the media by which the potential attendee user heard about the event, recording and storing such data for analysis. Such data can also be collected by various methodologies known to those skilled in the art including automated data collection from external marketing sources, such as, on-line promotional sources/websites by “tagging” links to the on-line event registration web page form or other event management website web pages and storing such data into a database for analysis, preferably transparent to the potential attendee user.

In another embodiment of the present invention, a method of facilitating event registration, planning, promotion, and management of continuing education events through an on-line event management website over a computer network that prevents inadvertent duplication of registration for the same event by the same potential attendee is provided. The method includes the steps of presenting to a potential attendee user's web browser a consolidated event listing web page to thereby display a plurality of events to a potential attendee user, and presenting to the potential attendee's web browser an on-line event registration web page form over the computer network, responsive to selection of an event displayed in the consolidated event listing web page. The method also includes receiving from the potential attendee user's web browser over the computer network a completed on-line event registration web page form for a selected event, and comparing the selected event to prior selected events preselected by the potential attendee user, responsive to receiving the completed on-line event registration web page form, to thereby detect a duplicate event registration for the same event, when existing, enhancing potential attendee user satisfaction.

An embodiment of the present invention also includes a method of facilitating event registration, planning, promotion, and management of events through an on-line event management website over a computer network that provides custom reports to the various users. For example, according to an embodiment of the present invention, a method of providing a custom report to an event sponsor includes presenting to each potential attendee user's web browser associated with a plurality of potential attendee users over the computer network a consolidated event listings web page to thereby display a plurality of user-selectable events to each potential attendee user, and presenting to each potential attendee user's web browser over the computer network, responsive to selection of an event displayed in the consolidated event listings web page, an on-line event registration web page form. The method also includes creating a custom event sponsor report, responsive to receiving the completed on-line event registration web page forms, and presenting the custom event sponsor report to an event sponsor user's web browser over the computer network, responsive to a query by the event sponsor. Advantageously, the event sponsor report can include select real-time registration data for the event along with access to the select data or a subset thereof for printing, and/or automated monitoring.

Embodiments of the present invention also include methods of managing continuing education through an on-line event management website over a computer network. For example, according to an embodiment of the present invention a method includes the step of presenting to each of a plurality of potential event attendee user's web browsers over the computer network a continuing education entry web page form to allow entry of past continuing education event record data for a corresponding plurality of potential event attendee users, to thereby form a continuing education event history data record for each of the plurality of potential event attendee users. The method also includes the step of receiving from each of the plurality of potential event attendee user's web browsers over the computer network a respective completed continuing education entry web page form for the respective potential attendee user, and creating continuing education event history data records for each of the plurality of potential event attendee users.

Embodiments of a method further can include: presenting to each potential event attendee's web browser over the computer network, responsive to selection of an on-line registrable continuing education event, an on-line event registration web page form for the continuing education event; receiving from each respective potential attendee user's web browser over the computer network the completed on-line event registration web page form for the selected continuing education event; and adding continuing education event record data to the continuing education event history data record for each respective potential attendee user, responsive to confirmation of completion of the selected continuing education event.

Embodiments of the present invention also include methods of marketing continuing education events through an on-line event management website over a computer network. According to an embodiment of the present invention, a method includes providing to each of a plurality of potential event attendee user's web browsers for a corresponding plurality of potential event attendee users a continuing education entry web page form to allow entry of past continuing education event record data, to thereby provide a continuing education event history data record repository for each of the plurality of potential event attendee users, and presenting to each of the plurality of potential attendee users an event management website registration web page form including a plurality of potential attendee user attribute fields to pre-register each potential attendee user with the on-line event management website. The potential attendee attributes preferably include potential attendee user location and potential attendee user e-mail addresses. Advantageously, the event management website registration can be provided to not only enhance ease of actual event registration, but can be provided such that completion of the event management website registration web page form is a prerequisite to providing the continuing education event history data record repository. Advantageously, this allows for providing selective marketing of a plurality of events, responsive to the potential attendee attributes provided by the potential attendee user in the event management website registration web page form, to thereby enhance event marketing and event attendance.

Embodiments of the present invention also include a computer readable medium that is readable by a computer to facilitate event registration, planning, and management of events through an on-line event management website over a computer network. The computer readable medium includes a set of instructions that, when executed by the computer, cause the computer to perform the operations of: providing to an event management member user's web browser over the computer network a new-event-creation web page form having a plurality of database input fields, and adding a new event data record to a database associated with the on-line event management website, responsive to data entered in the new-event-creation web page form by the event management member user. Instructions also include those to perform the operations of creating an on-line event registration web page form, responsive to release of the new event by the event management member user, and adding the new event to a consolidated event listing web page, responsive to release of the new event by the event management member user, to thereby display the new event to a plurality of potential attendee users.

The instructions also include those to perform the operation of presenting substantially simultaneously over the computer network to a plurality of potential attendee user's web browsers associated with a corresponding plurality of separate and spaced apart potential attendee user's computers, the consolidated event listing web page displaying the new event, and presenting substantially simultaneously over the computer network to each of the plurality of potential attendee user's computers through their respective potential attendee user's web browser, responsive to selection of the new event on the consolidated event listing web page by each respective potential attendee user, the on-line event registration web page form for the new event. The instructions can further include those to perform the operations of receiving from each respective potential attendee user's web browser over the computer network the completed on-line event registration web page form for the new event, and adding continuing education event record data to a continuing education event history data record for each respective potential attendee user, responsive to confirmation of completion of the new event registered using the on-line event registration web page form.

Advantageously, embodiments of the present invention provide an event management system particularly adapted to provide significant efficiencies in operations, especially for continuing education departments or other departmental organizations requiring event management functionality. Events management member personnel (staff) are provided access to all aspects of the events they manage. Event management member personnel, using a web-based new event-creation form, can enter and edit events, promote events, and view current registrants, all in real-time. Advantageously, the events management program product includes functionality to allow multiple authorized users to initialize new events, enter event data, edit the event, and/or review event planning data, real-time, thereby enhancing event planning and evaluation. Advantageously, the events management system also provides a high level of access for event coordinators so that the events management program product or software is more event driven. Advantageously, event sponsors and directors can be provided real-time access to event data. Further, advantageously, the event management system is also easy to administer, secure, and back-up.

### BRIEF DESCRIPTION OF THE DRAWINGS

So that the manner in which the features and advantages of the invention, as well as others which will become apparent, may be understood in more detail, a more particular description of the invention briefly summarized above may be had by reference to the embodiments thereof which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1 is a schematic block diagram of a system to facilitate event registration, planning, promotion, and management of events through an on-line event management website over a computer network according to an embodiment of the present invention;

FIG. 2 is a schematic block diagram of a server to facilitate event registration, planning, promotion, and management of events through an on-line event management website over a computer network according to an embodiment of the present invention;

FIG. 3 is a schematic block diagram of a system to facilitate event registration, planning, promotion, and management of events through an on-line event management website over a computer network according to an embodiment of the present invention;

FIGS. 4A-4B are a schematic block diagrams of major functions of an events management program product to facilitate event registration, planning, promotion, and management of events through an on-line event management website over a computer network according to an embodiment of the present invention;

FIGS. 5A-5B are schematic diagrams of on-line website registration web page forms used to facilitate event registration, planning, promotion, and management of events through an on-line event management website over a computer network according to an embodiment of the present invention;

FIG. 6 is a schematic diagram of an event-creation web page form used to facilitate event registration, planning, promotion, and management of events through an on-line event management website over a computer network according to an embodiment of the present invention;

FIG. 7 is a schematic diagram of a consolidated event listing web page used to facilitate event registration, planning, promotion, and management of events through an on-line event management website over a computer network according to an embodiment of the present invention;

FIG. 8 is a schematic diagram of an on-line event registration web page form used to facilitate event registration, planning, promotion, and management of events through an on-line event management website over a computer network according to an embodiment of the present invention;

FIGS. 9-11 are schematic diagrams of event management web pages illustrating user profile data provided by the on-line website registration web page forms illustrated in FIGS. 5A-5B according to an embodiment of the present invention;

FIG. 12 is a schematic diagram of a user event registration web page for displaying events registered through an on-line event management website over a computer network according to an embodiment of the present invention; illustrating user event registration data;

FIG. 13 is a schematic diagram of an e-commerce web page used to facilitate event registration, planning, promotion, and management of events through an on-line event management website over a computer network according to an embodiment of the present invention;

FIG. 14 is a schematic diagram of a continuing education entry web page form used to record earned continuing education event credits through an on-line event management website over a computer network according to an embodiment of the present invention;

FIG. 15 is a schematic diagram of an on-line continuing education transcript web page form used to display earned continuing education event credits through an on-line event management website over a computer network according to an embodiment of the present invention;

FIG. 16 is a schematic diagram of an event management member user logon web page form used to access various functions of an on-line event management website over a computer network according to an embodiment of the present invention;

FIG. 17 is a schematic diagram of a continuing education course catalog web page used to access various on-line continuing education events through an on-line event management website over a computer network according to an embodiment of the present invention;

FIG. 18 is a schematic flow diagram of a method of facilitating event registration, planning, promotion, and management of events through an on-line event management website over a computer network according to an embodiment of the present invention;

FIG. 19 is a schematic flow diagram of a method of facilitating event registration, planning, promotion, and management of events through an on-line event management website over a computer network according to an embodiment of the present invention;

FIG. 20 is a schematic flow diagram of a method of facilitating event registration, planning, promotion, and management of events through an on-line event management website over a computer network according to an embodiment of the present invention;

FIG. 21 is a schematic flow diagram of a method of facilitating event registration, planning, promotion, and management of events through an on-line event management website over a computer network according to an embodiment of the present invention;

FIG. 22 is a schematic flow diagram of a method of managing continuing education through an on-line event management website over a computer network according to an embodiment of the present invention;

FIG. 23 is a schematic flow diagram of a method of marketing continuing education events through an on-line event management website over a computer network according to an embodiment of the present invention; and

FIG. 24 is a schematic flow diagram of a method of marketing continuing education events through an on-line event management website over a computer network according to an embodiment of the present invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout. The prime notation, if used, indicates similar elements in alternative embodiments.

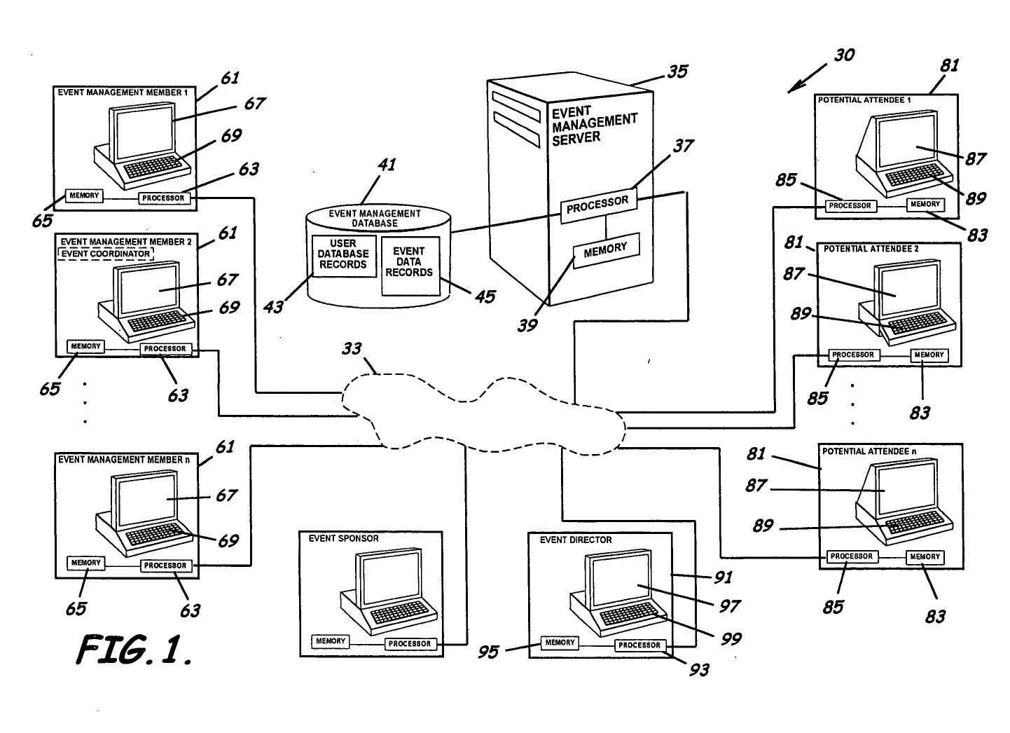

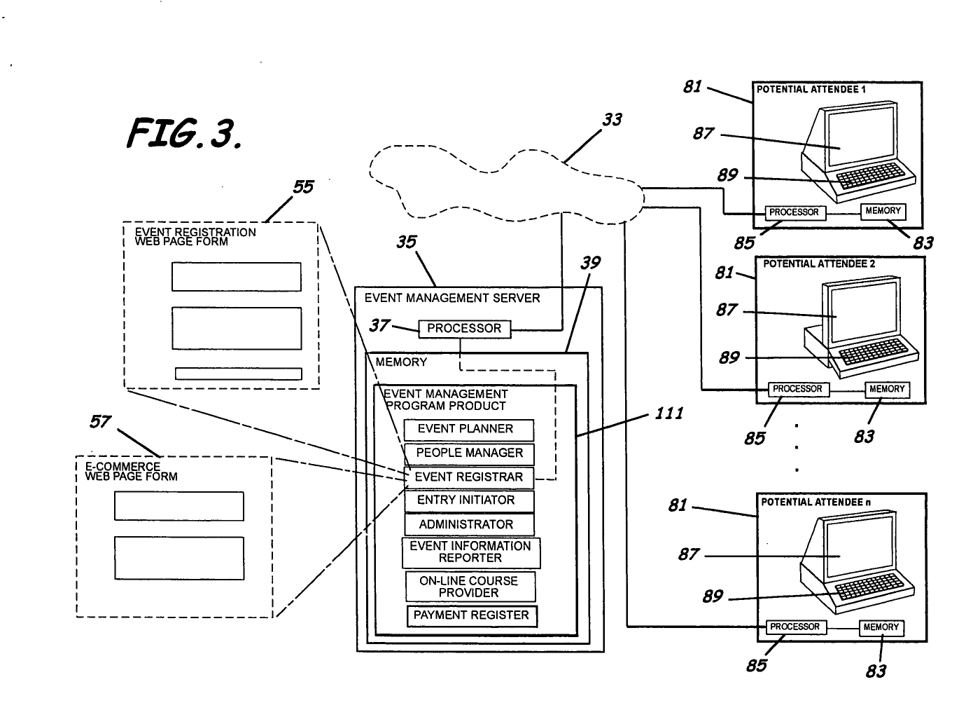

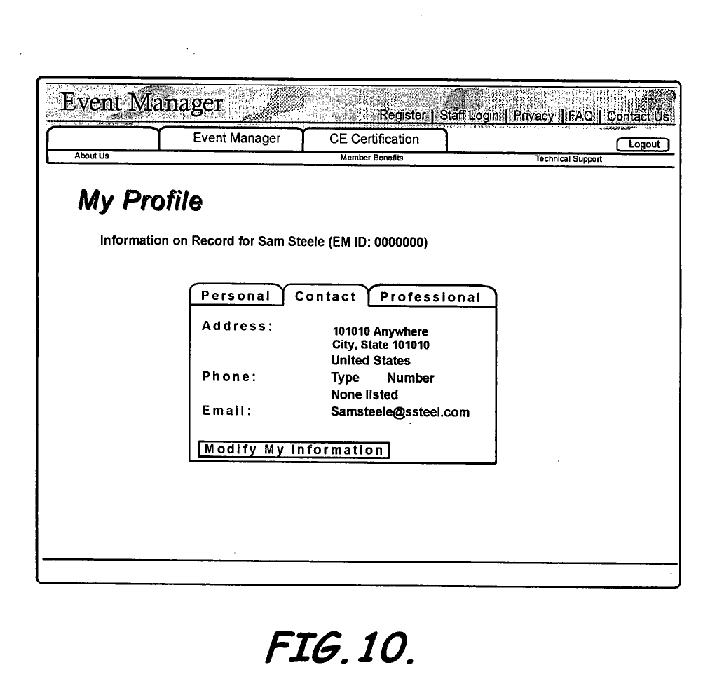

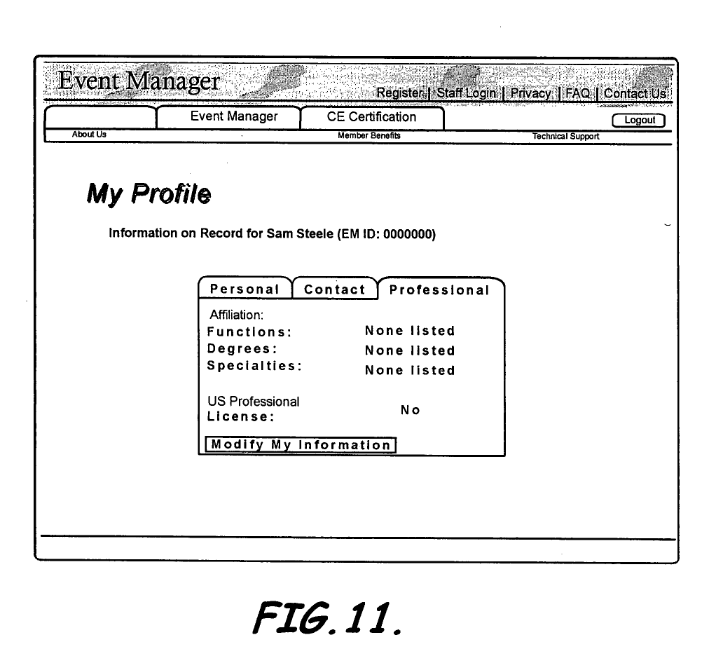

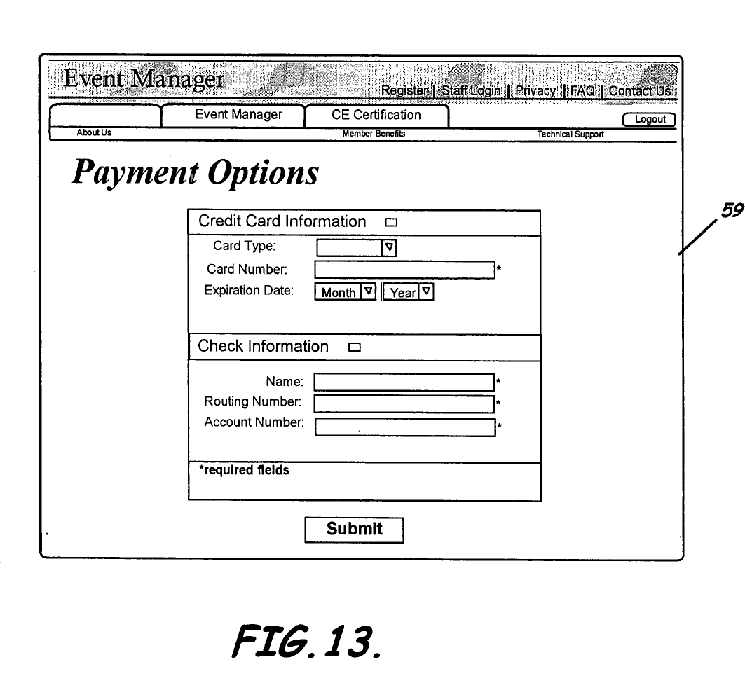

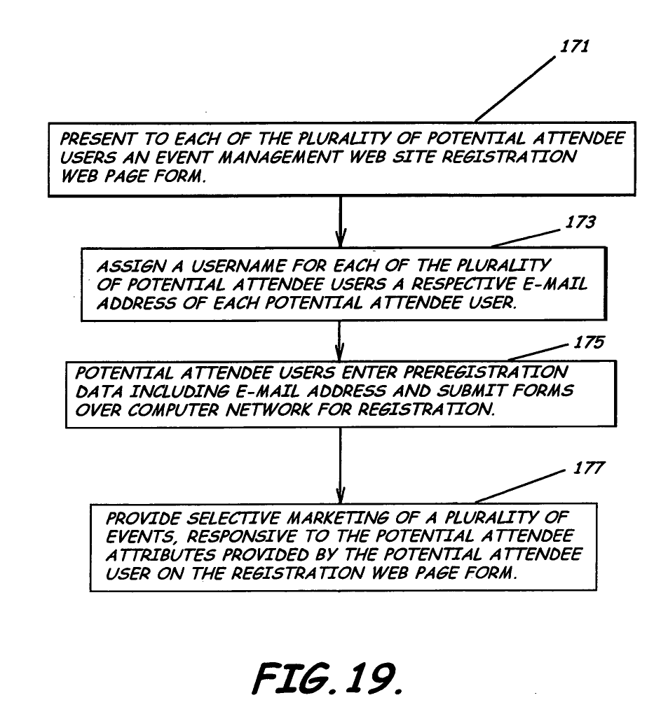

As illustrated in FIGS. 1-24, embodiments of the present invention advantageously provide a system, program product, and methods of facilitating event registration, planning, and management of various types of events through an on-line event management website. These events can include but are not limited to continuing medical education events, continuing legal education events, professional training classes, other forms of instructional seminars, and various kinds of entertainment events.

For example, as perhaps best shown in FIGS. 1-17, a system 30 is provided to facilitate event registration, planning, promotion, and management of events, e.g., continuing education events, through an on-line event management website over a computer network 33, according to the preferred embodiment of the present invention. The system 30 includes at least one host computer hosting the online event management website accessible to the computer network 33 to define an event management server 35. The event management server 35 has a processor 37 and memory 39 coupled to the processor 37 to store operating instructions therein. Note, it should be understood that the preferred specific server identified above is given by way of example and that other types of servers or computers can be used. The server 35 shown schematically in, for example, FIG. 1 represents a server or server cluster or server farm in the architecture and is not limited to any individual physical server. The server site may be deployed as a server farm or server cluster managed by a serving hosting provider. The number of servers and their architecture and configuration may be increased based on usage, demand and capacity requirements for the system 30.

The system of 30 also includes a database 41 accessible to the processor 37 of the event management server and containing user data records 43 and event data records 45 related a plurality of events such as, for example, accredited continuing education events. Due to scalability, speed, and performance, the database 41 is preferably a Microsoft SQL Server 2000 database, available through the Microsoft Technology Center, Austin Tex., but can take other forms known to those skilled in the art.

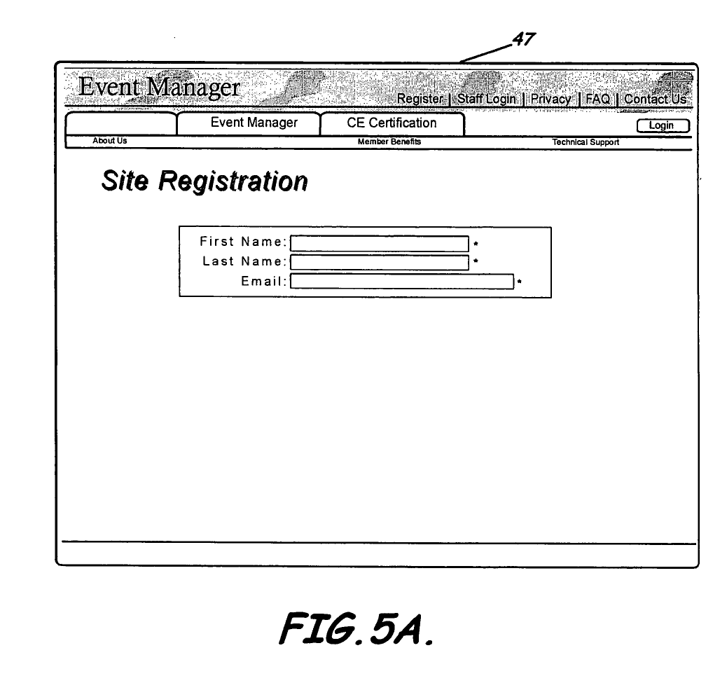

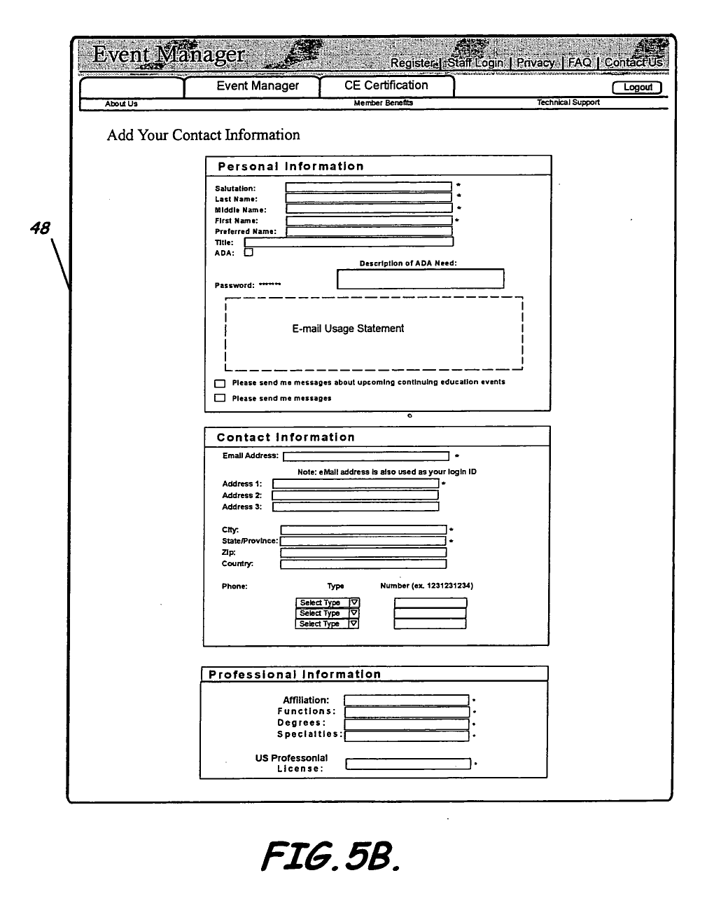

The user data records 43 stored in the database 41 include user attribute data preferably entered through use of a website registration web page form or forms 47, 48, such as those illustrated in FIGS. 5A and 5B, respectively. As shown in FIG. 5B, the attribute data can include, for example, personal profile data such as a user name and password, proper name, preferred name, title, ADA requirements, and/or willingness to receive e-mail updates regarding future events. The user attribute data can also include contact data, such as, the user's address and phone number or e-mail address, which is also preferably the user name for the website. The user attribute data can also include professional data including professional affiliation, educational degrees received, professional specialties, and professional licenses currently held. The user attribute data in the user data records 43 can provide event management marketing members a ready data mine which provides the ability to deliver focused marketing of future events, thus improving marketing efficiency.

In the preferred configuration, the user e-mail address provided in the website registration, such as that illustrated in FIG. 5A, and is utilized by the system 30 as the user name. Advantageously, utilizing a standardized user name, such as that provided through use of a user's e-mail address, improves user satisfaction by allowing the system 30 to provide some level of user authentication and allows the system 30 to provide functionality to prevent incidents of duplicate event registrations, such as those caused when a user forgets the user's website name and password, and thus, provides a different user name to register for the same event registered on a different day under a different user name.

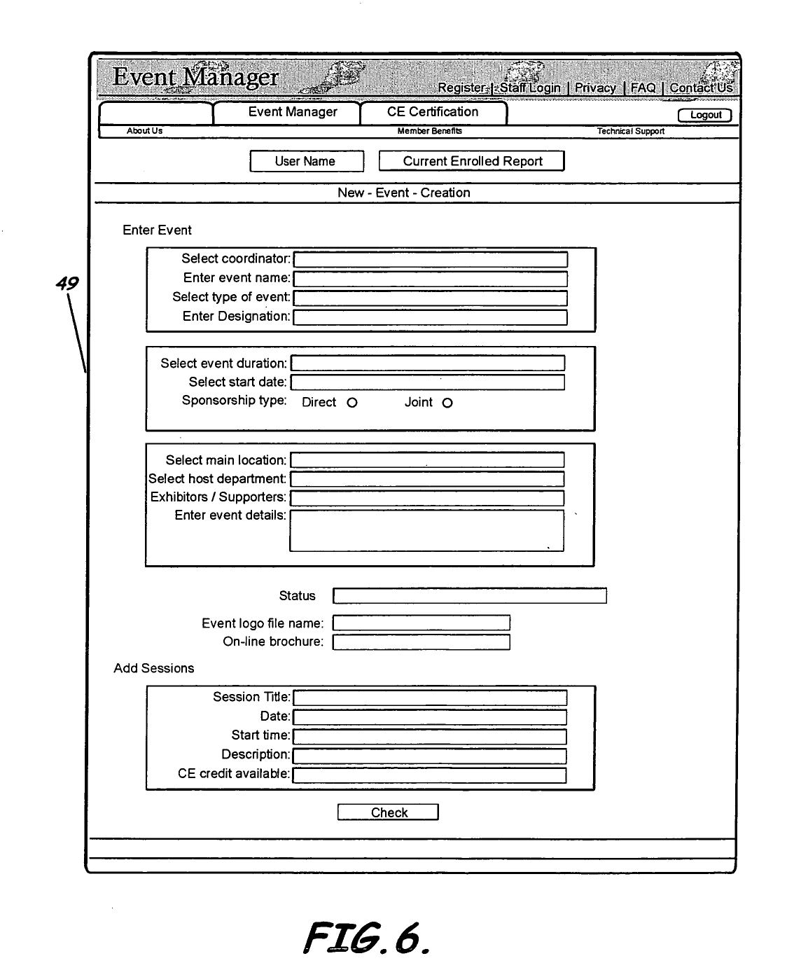

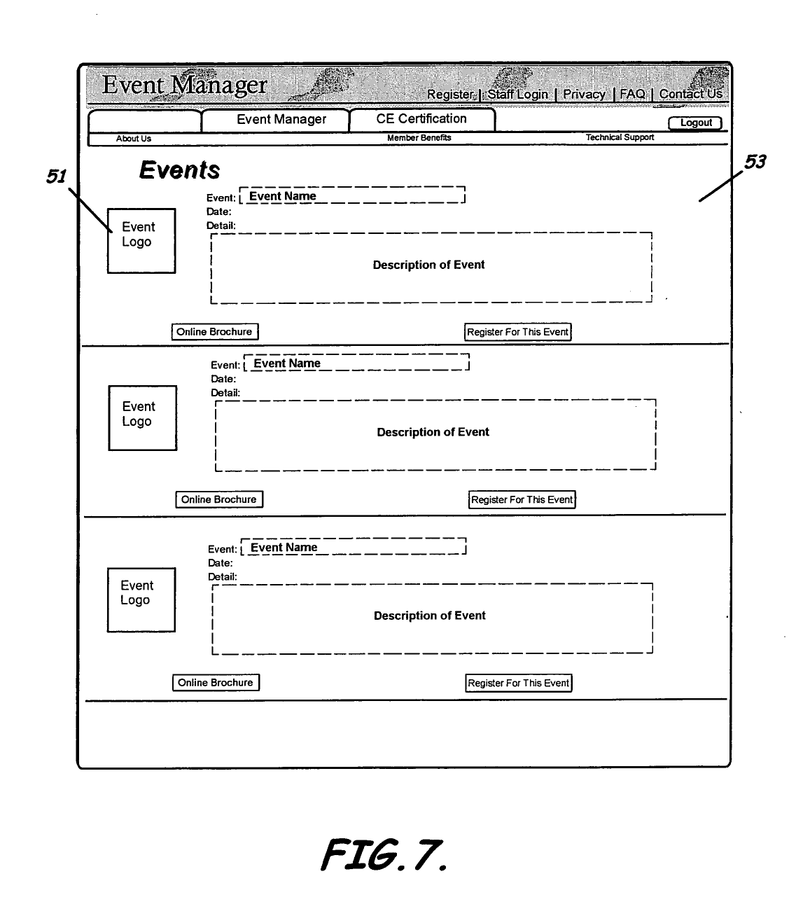

The event data records 45 stored in the database 41 can include various event attributes, preferably entered through use of a new-event-creation web page form 49, such as that illustrated in FIG. 6. The event attributes can include, for example, the name of a primary event coordinator, the name and the type of the event, event designation, event location, event duration, event start date, sponsorship type, event host department, event exhibitors and/or supporters, event details, and event status, and for each event session, a session title, date, start time and/or duration, description, and education credit, if available. The event data records 45 can also include a file location for a logo or icon 51 preferably in the form of a thumbnail sized picture or image to be used on a consolidated event listing web page 53 such as that illustrated in FIG. 7. The event data records 45 can also include a file location of an on-line brochure (not shown) typically scanned from a hard-copy version to provide a user a hard-copy of the event description to provide to others and/or to allow off-line registration using a postal system or facsimile option.

The system 30 also includes at least one but preferably a plurality of event management member user's computers 61 each positioned remote from the event management server 35 and accessible to the computer network 33 and having a processor 63 and memory 65 coupled to the processor 63 to store operating instructions therein and to receive database records. The event management member user's computers 61 each also include a display 67 in communication with the processor 63 to display data records using an associated event management member user's web browser, and a user interface 69 in communication with the processor 63, to provide each event management member user with on-line web-based access over the computer network 33 to the event data records 45, to thereby view and edit event data stored in the database 41.

The event management member user, identified above, can include various event management staff members and/or event coordinators. A primary event coordinator, however, is preferably assigned to each scheduled event in order to ensure overall accountability for the event. Correspondingly, preferably at least one of the plurality of event management member user's computers 61 is an event coordinator user's computer in communication with the computer network 33 to provide the event coordinator user with on-line web-based access to event data records 45 over the computer network 33. The event coordinator or an assistant, normally performs the function of adding new event records 45 to the database 41 for a particular assigned event using a new-event-creation web page form 49 (FIG. 6). Other event management member user's and/or the event coordinator user, using the same form or a similar form, then access the new event data to edit the then pending new event data records 45 stored in the database 41.

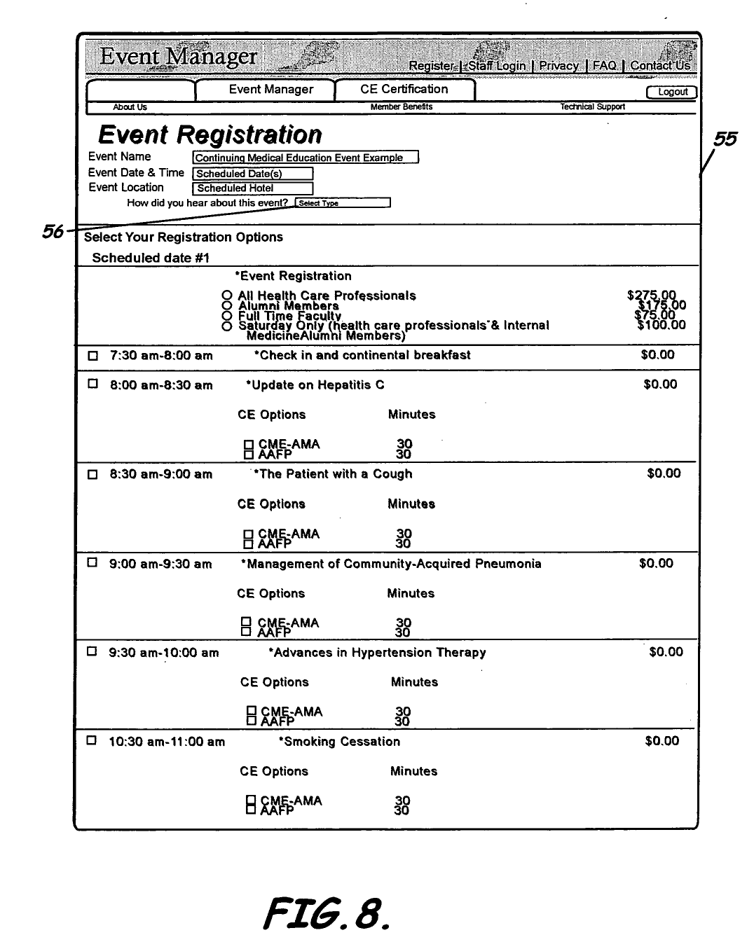

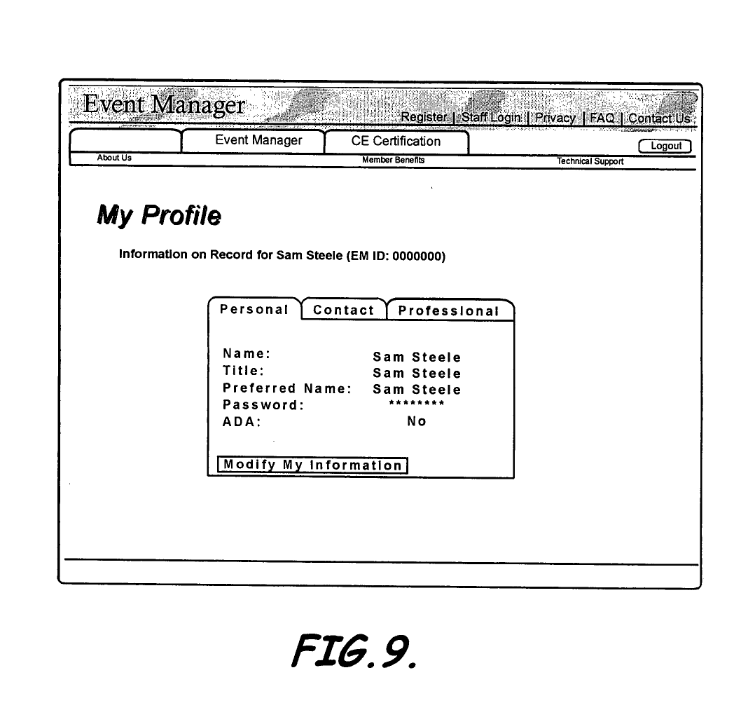

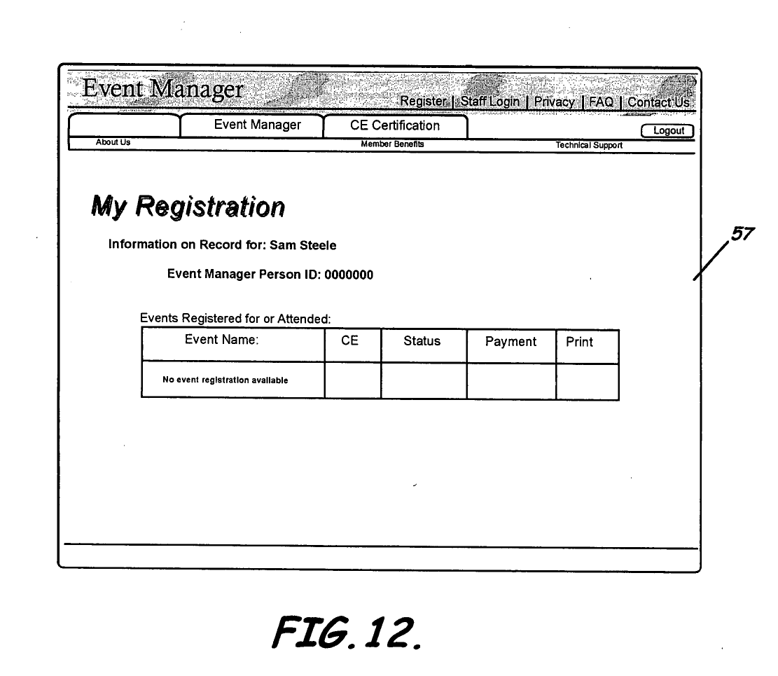

The system 30 also includes a plurality of potential attendee user's computers 81 each positioned at a respective plurality of potential attendee user sites remote from the event management server 35 and accessible to the computer network 33. Each potential attendee user's computer 81 has a processor 83 and memory 85 coupled to the processor 83 to store operating instructions therein and to receive database records. Each potential attendee user's computer 81 also includes a display 87 in communication with the processor 83 to display data records using an associated potential attendee user's web browser and a user interface 89 in communication with the processor 83 to provide the potential attendee user with on-line web-based access to user data records 43 over the computer network 33. Advantageously, this configuration allows a user to view and/or edit user data including profile data illustrated in FIGS. 9-11, view registration data illustrated in FIG. 12, receive automatic notifications of upcoming events, and view and print continuing education credit data and/or certificates. The user is also provided access to event data records 45 over the computer network 33 to thereby view event data such as that shown in the consolidated event listing web page 53 illustrated in FIG. 7, and the on-line event registration web page form 55 illustrated in FIG. 8 to self-register for at least one scheduled event.

Each event generally has an event director. Correspondingly, the system 30 can also include at least one but preferably a plurality of event director user computers 91 assigned to each respective event director for each of a plurality of events. Each event director user computer 91 is preferably positioned at an event director user site remote from the event management server 35 and accessible to the computer network 33. Each event director user computer 91 has a processor 93, and memory 95 coupled to the processor 93 to store operating instructions therein and to receive database records. Each event director user computer 91 also includes a display 97 coupled to the processor 93 to display database records using an event director user's web browser and a user interface 99 coupled to the processor 93 to provide an event director user with on-line web-based access to the event data records 45 over the computer network 33 to thereby allow the respective event director user to review real-time event registration and attendance levels for the event director's event.

Each event typically also has at least one event sponsor. Correspondingly, the system 30 can also include at least one but preferably a plurality of event sponsor users computers 101 assigned to at least some of the plurality of events. Each event sponsor user computer 101 is preferably positioned at a separate event sponsor user site remote from the event management server 35 and accessible to the computer network 33. Each event sponsor user computer 101 has a processor 103 and memory 105 coupled to the processor 103 to store operating instructions therein and to receive database records. Each event sponsor user computer 101 also includes a display 107 coupled to the processor 103 to display database records using an event sponsor user's web browser and a user interface 109 coupled to the processor 103 to provide an event sponsor user with on-line web-based access to event data records 45 over the computer network 33.

Advantageously, this allows the respective event's sponsor or sponsors to review various levels of real-time event registration data, depending upon the type of event, and event attendance levels for each respective sponsor's event. Note, depending upon the type of event, different levels of access to event data records 45 can be provided to the event sponsor or sponsors. For example, if the event is a continuing medical education event, regulatory requirements may dictate that event sponsors may not be provided personally identifiable information about event attendees, thus, such event sponsors would only be provided high-level data such as, e.g., headcount, number of specialists, and type of specialty. If the event is an entertainment event, the event sponsors may instead be provided detailed personally identifiable information about each event attendee.

Note, although illustrated as a keyboard, the input device 69, 89, 99, 109, can include other forms of device known to those skilled in the art such as, for example, a light pen, magnetic or optical card reader, trackball, touch screen, touchpad, or mouse. Further, the event management member user's computers 61, potential attendee user's computer 81, event director user's computer 91, and event sponsor user's computer 101, each can take various forms known to those skilled in the art such as, for example, a desktop personal computer, portable computer, a PDA, a mobile telephone, and still other devices for accessing the Web, that are adapted to interface with the computer network 33 while positioned remote from the event management server 35.

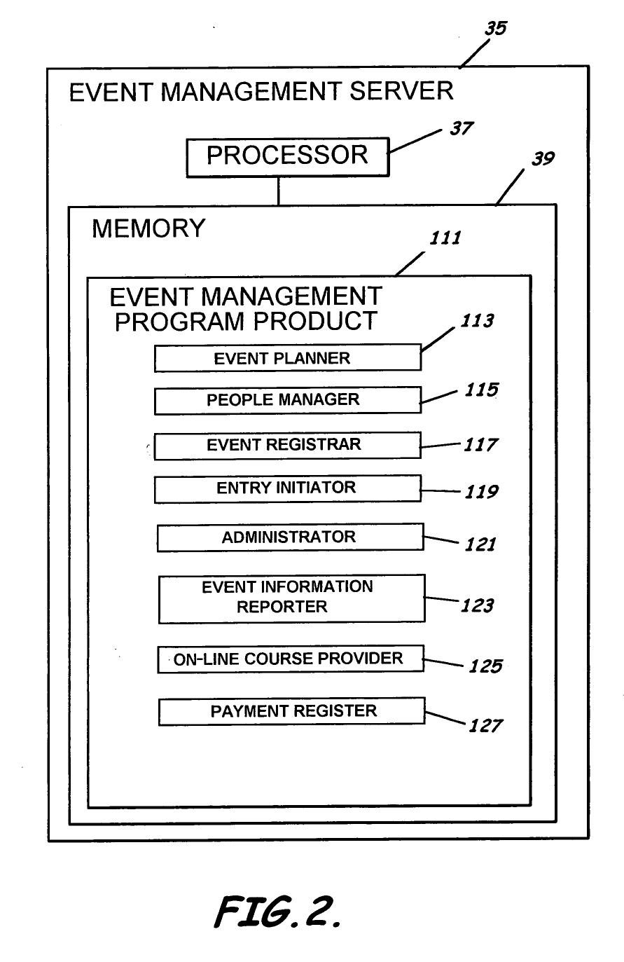

As perhaps best shown in FIGS. 2-4B, the system 30 also includes an event management program product 111 stored in the memory 39 of the event management server 35 which provides the server 35 the functionality to facilitate event registration, planning, and management of the various events over the computer network 33. For example, the events management program product 111 includes functionality to allow multiple authorized users to initialize a new event, enter event data, edit the event, and/or review event planning data, real-time, thereby enhancing event planning and evaluation. Advantageously, the events management program product 111 can also provide for user on-line event self-registration and e-commerce to enhance receiving real-time registration data, to thereby further enhance event planning and evaluation.

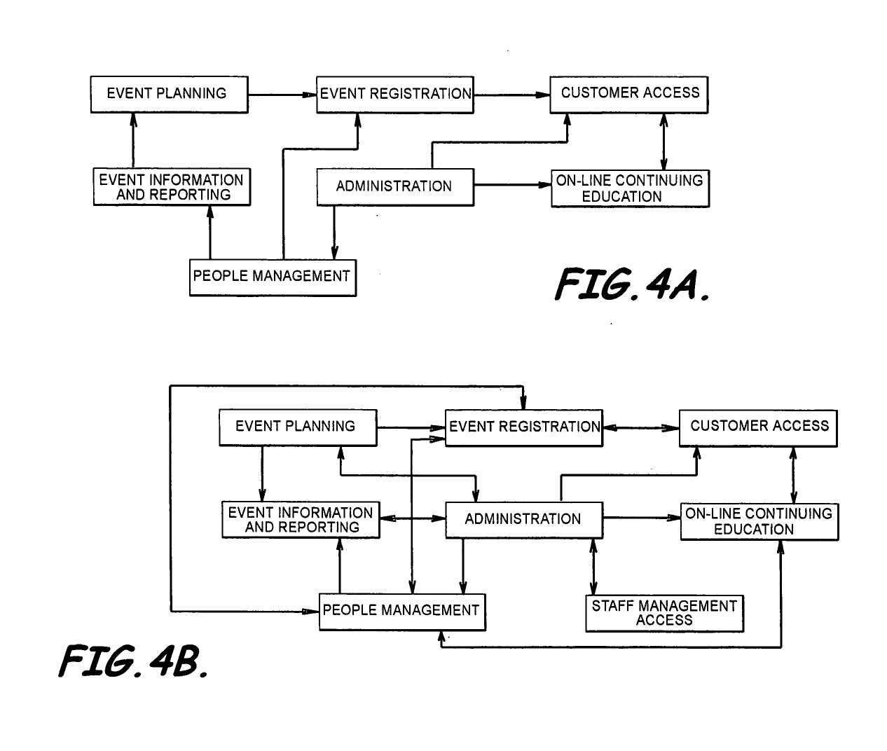

According to embodiments of the present invention, the events management program product 111 is a web-based program that provides web-based functionality. Accordingly, beyond the installation of a common web browser, specialized software installation is not necessary. Because embodiments of the events management program product 111 are web-based, such program product is portable to multiple computer systems, and is easily accessible by multiple concurrent users at a single time through web access, providing a single focal location for substantially all event information. Some of the major functions of the events management program product 111 are illustrated in FIGS. 4A-4B. Note, the event management program product 111 can be in the form of microcode, programs, routines, and symbolic languages that provide a specific set for sets of ordered operations that control the functioning of the hardware and direct its operation, as known and understood by those skilled in the art.

According to an embodiment of the present invention, the event management program product 111 includes an event planner 113 which advantageously can support all aspects of planning an event including initializing a new event, providing for entry of new event data, and providing for editing for event data. This can be accomplished in a single session or multiple sessions over multiple days spanning a period of time of a year or more. According to an embodiment of the present invention, the event planner 113 can provide to an event management member user's web browser a new-event-creation web page form 49 (FIG. 6) having a plurality of database input fields to allow entry of new event data for a new event and/or for editing of a pending event. In response to the data entered by an event management member user in the web page form 49, the event planner 113 adds a new event data record to the database 41. If the event is a pending event, the event planner 113 can provide the same or a slightly modified web page form 49 to allow the user to edit the pending event data record stored in the database 41. Because the web-based functionality provides a single location for substantially all available event data in the event management system 30, the various event management members including the event coordinator or coordinators need not individually save changes to the local computers but can make and maintain all changes through the event management server 35 anywhere web access is available. Advantageously, this provides real-time event development data dissemination and real-time updates simultaneously to all other event management member users, thereby reducing event management overhead.

The event management program product 111 also includes a people manager 115 which can store all data related to people (users) and events. The users can be classified as event attendees or potential attendees, event speakers, event sponsors, event coordinators, event directors, and event management members to enhance data access to and for assigning access permission levels. According to an embodiment of the present invention, the people manager 115 can provide to a potential attendee user's web browser event management website registration web page forms 47, 48 (FIG. 5A-5B) including a plurality of potential attendee user attribute data fields to allow entry by a potential attendee user of user attributes. In response to the data entered by the potential attendee user in the registration web page forms 47, 48, the people manager 115 stores in the database 41 user data records including the user attribute data (see also FIGS. 8-10). In response to completing the registration, the user attribute data is then available for editing in order to allow the user to provide user updates which allow for enhance marketing to the user as the user's needs change as reflected by changes in the user's attribute profile.

The event management program product 111 also includes an event registrar 117 which functions to associate users stored in the database 41 to events. That is, the event registrar 117 can access the user data records 43 in the database 41 and the event data records 45 in the database 41 to associate selected users to selected events. For example, according to an embodiment of the present invention, the event registrar 117 can provide to a potential attendee user's web browser an event registration web page form 55 (FIG. 8), unique to each available event, to register for a user selected event. Correspondingly, in response to initiating registration for the selected event by selecting the various event fields, the event registrar 117 receives the selection data and associates the potential attendee user to the selected event. Although the event registration web page form 55 for each available event can be accessed directly, the event management website preferably includes a consolidated events listing web page 53 (FIG. 6) to provide user review and selection of registrable (selectable) events, thus allowing user-self registration through the event registrar 117. Further, advantageously the website provides each user a user current-registration web page 57 (FIG. 12) to provide each of the plurality of attendee users a respective list of prior registered events, negating a need to directly contact event management members for such event data.

The event register 117 is also preferably positioned to provide an e-commerce web page form 59 (FIG. 12) to the plurality of potential attendee users through each respective potential attendee user's web browser, to further provide each potential attendee user real-time self-registration. The event register 117 can also provide each potential attendee user on-line payment options including on-line check and on-line credit card payment options, or other forms of on-line payment options know to those skilled in the art, and according to an embodiment of the present invention, telephone-credit card payment instructions. Advantageously, by providing such immediate payment options during the event registration process, the event coordinator user for the respective event is provided with substantially real-time registration data to further enhance event planning and evaluation.

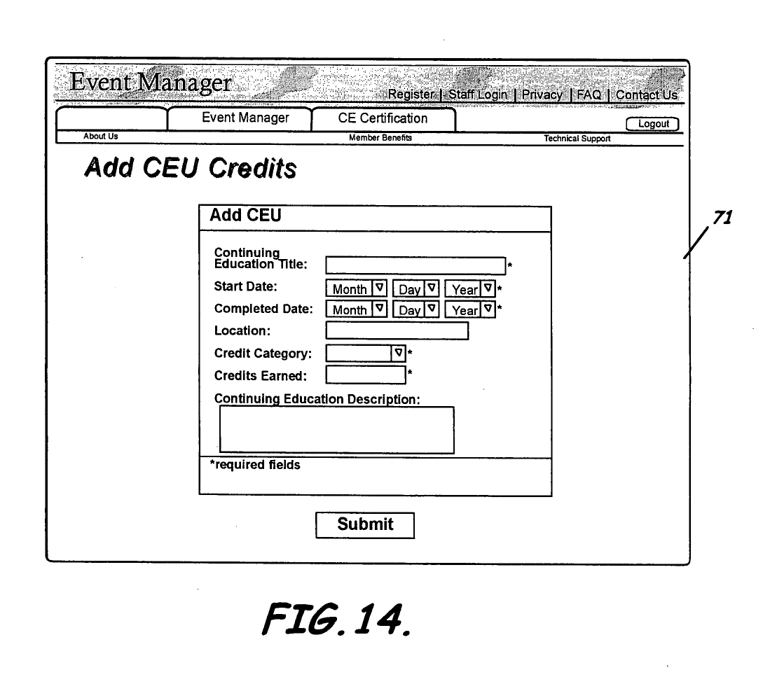

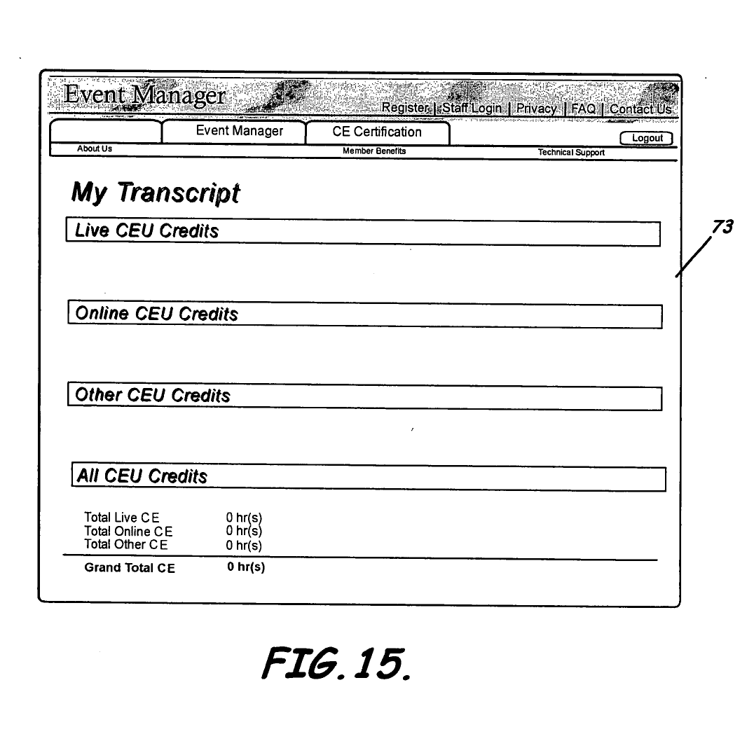

The event management program product 111 also includes an entry initiator 119 which functions to allow users (customers) having user data records 43 stored in the database 41 to login through use of preferably a user name/password combination. That is, the entry initiator 119 can provide both user login access for and authentication of a user to allow entry of and “customer” access to data stored in the database 41, according to the user's classification. For example, as will be described later, potential attendees can establish and access a repository of continuing education credits registered through the on-line event management website and those earned elsewhere (FIG. 14), and review education credit transcripts (FIG. 15), view and print continuing education certificates (not shown), register for events (FIG. 8), review current registrations (FIG. 12), and modify their contact or profile information illustrated in FIGS. 9-11; while event coordinators and event directors can view registrations and print reports for their respective events.

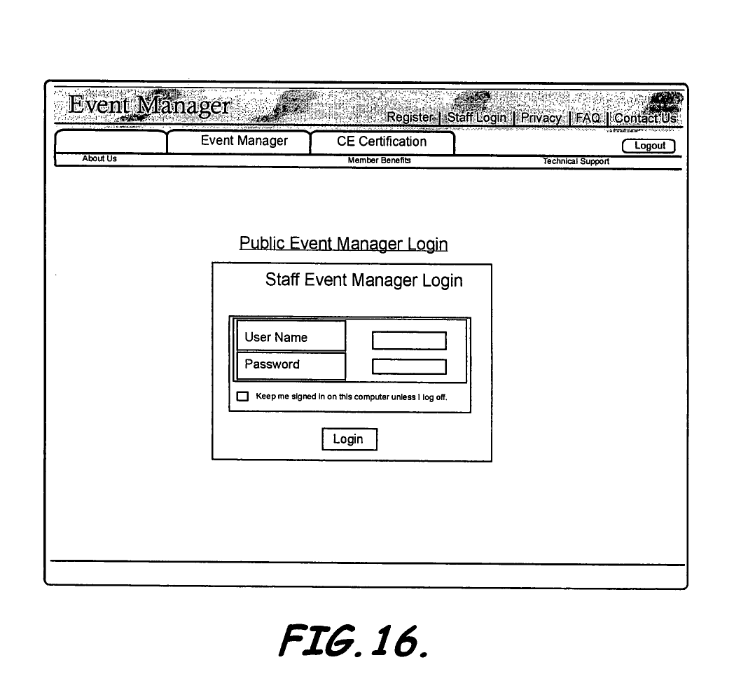

The event management program product 111 also includes an administrator 121 which functions to manage and restrict user access to the data stored in the database 41 based upon permission levels assigned to the individually users. Correspondingly, the administrator 121 can access the user data records 43 in the database 41 to determine such user permission levels and to thereby restrict access to the data in the database 41. Further, administrators and users can be added and assigned permission levels through the administrator 121. These permission levels can be based on user classification and/or on a hierarchy within each to user classification. For example, a primary event coordinator or event management program director may have a higher permission level than other event management members. Also for example, an event sponsor for an art show event may have a higher permission level with respect to, e.g., art show registrants, than an event sponsor for a continuing medical education event. Further, customer user access to the database 41 initiated through the entry initiator 119 is preferably provided through the administrator 121, to thereby restrict such access based on the assigned permission levels. Event management member administration and staff access can be provided through a separate login such as, for example, that illustrated in FIG. 16.

The event management program product 111 also includes an event information reporter 123 which functions to access data in the database 41 to thereby produce reports related to events selected by the respective user. Advantageously, the reports are formatted to be viewed over the network 33 by the user's web browser. According to an embodiment of the present invention, through use of the administrator 121, event management administration and staff can access and view data related to any event stored in the database 41, assembled as web browser viewable reports by the event information reporter 123, to thereby allow for real-time management of such events.

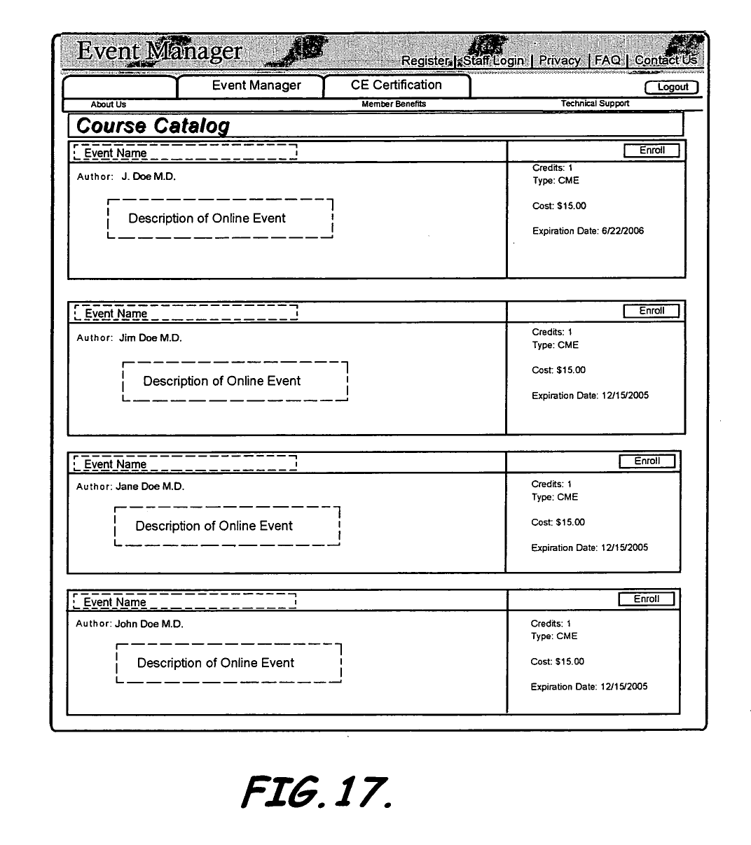

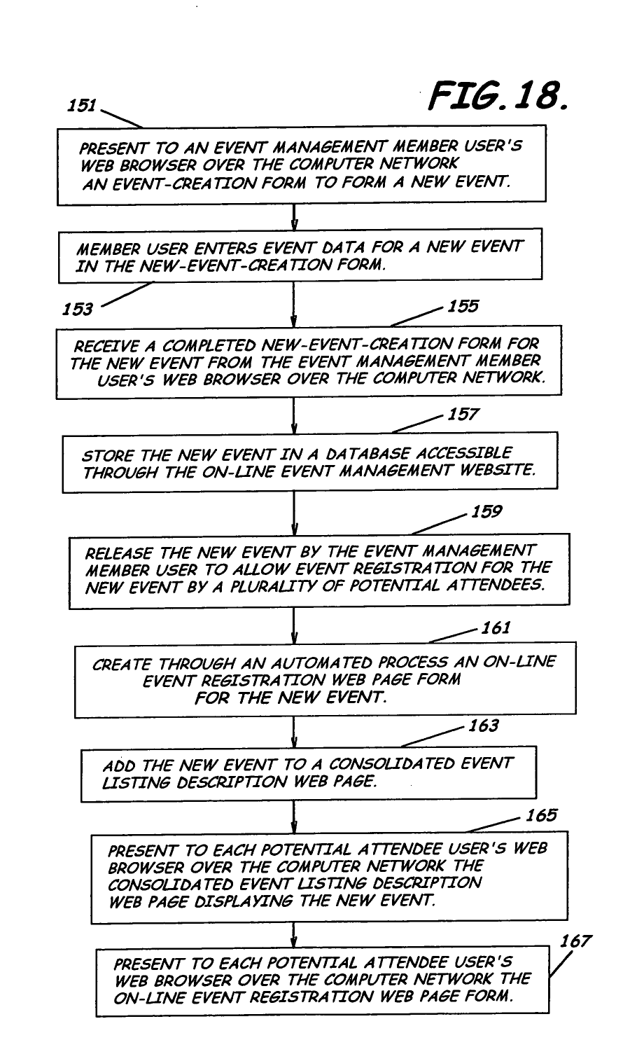

The event management program product 111 also includes an on-line course provider 125 which functions to associate users, stored in the database 41, to on-line educational courses. That is, the on-line course provider 125 can access the user data records 43 in the database 41 and on-line course data records (not shown) in either the database 41 or other on-line provider database, to associate users to selected on-line educational courses. For example, according to an embodiment of the present invention, the on-line course provider 125 can provide to a potential attendee user's web browser a course catalog web page (FIG. 17), to enroll/register for a user selected on-line course event. Correspondingly, in response to initiating enrollment for the selected on-line course event by selecting the course from the course catalog, the on-line event provider 125 associates the potential attendee user to the selected event. The on-line course is added to the individual potential attendee user's on-line course web page (not shown), provided through the on-line event management website, which preferably includes current courses, future courses, and completed courses. In response to the enrollment, the potential attendee user can begin viewing the on-line course or can access the course later, preferably through the individual potential attendee user's on-line course web page, for viewing at a more convenient time. The on-line event provider 125 includes a certificate creation function which preferably integrates with an on-line payment function, e.g. payment register 127, described below, to provide an on-line generated course completion certificate, responsive to course completion and on-line payment.

The event management program product 111 can also include a payment register 127 positioned to perform the operations of: receiving for each event, from an event management member user, a payment item description and a payment amount; and associating each payment item description and payment amount with a respective event account record positioned within and forming a part of each corresponding on-line course event data record 45. The payment register 127 also performs the operations of accessing event data records 45, responsive to registration of a potential attendee user through the event registrar 117, and associating a corresponding event registration on-line payment transaction with the event account record for each event registered.

As shown in FIGS. 1-18, embodiments of the present invention also provide methods of facilitating event registration, planning, promoting, and management of events through an on-line event management website over a computer network 33. The events associated with the on-line event management website can be, and include but are not limited to, continuing medical education events, continuing legal education events, professional training classes, other forms of instructional seminars, and various kinds of entertainment events. For example, according to an embodiment of the present invention a method includes presenting to an event management member user's web browser over the computer network 33 a new-event-creation form 49 (FIG. 6) to form a new event (block 151). The new-event-creation form 49 preferably has a plurality of planning event data fields including event time, event location, event description, and number of education credits assigned or available to the new event. An event coordinator user or other event management member user enters event data (block 153) for a new event in the new-event-creation form 49. The new-event-creation form 49 or similar form is also provided to perform editing of a new but pre-existing event being developed.

Various types of events can occur either only once or intermittently over extended periods of time, where others, such as, for example, Grand Rounds events can recur monthly, weekly, or even daily. Further, event planning is typically a process accomplished during multiple data entry sessions often by different event management member users over multiple days spanning a period of time of a year or more. Correspondingly, the event planning system 30 is sufficiently flexible to not only accommodate planning for events requiring extended preparation time, but also, events characterized by having information for the event only accessible or selectable the day before the event. Thus, advantageously, the new-event-creation form 49 is a web-based form provided over the network 33 which can be viewed without the need for specialized software programs to be installed on the various users' computers, requiring only a standard web browser, generally provided along with the operating system software for most computers, or suitable substitute, to view and/or manipulate data within the new-event-creation form 49. That is, regardless of the location of the event management member user, the data entered or selected within the new-event-creation form 49 for the new event, received (block 155) from the event management member user's web browser over the computer network 33 and stored (block 157) in database 41, is accessible through the on-line event management website.

Once event planning is completed, an event management member user, preferably an event administrator, releases the new event (block 159) to allow event registration for the new event by a plurality of potential attendees. An event management program product 111 stored in the memory 39 of an event management server 35, in response to the release, automatically extracts or retrieves the event data and creates an on-line event registration web page form 55 (block 161) such as, for example, that illustrated in FIG. 8. The on-line event registration web page form 55 preferably includes a plurality of registration event data fields corresponding to the planning event data fields associated with the new-event-creation form 49. Where the event is an education-based or continuing education event, the registration event data fields in the on-line event registration web page form 55 preferably include user selectable event attendance and education credit options to thereby provide custom registration for each of the plurality of potential attendee users.

In order to market the existence and availability of the new event, indicia of the new event, generally provided or referenced in the new-event-creation form 49, is then added (block 163) to a consolidated event listing web page 53 (FIG. 7). Also in response to release of the new event by the event management member user, the consolidated event listing web page 53 displaying the new event is presented (block 165) to each potential attendee user's web browser over the computer network 33 to thereby market the new event to the plurality of potential attendee users. The consolidated event listing web page 53 provides a convenient web-based location for users to visit using their web browser to search for events of interest that are within their unique time constraints, physical location, professional or technical category or specialty, or field of interest. Upon selection of a link by a potential attendee user, to a respective on-line event registration web page form 55, e.g., logo 51 (FIG. 7), that user is presented on the on-line event registration web page form 55 (block 167) over the computer network 33 through the respective user's web browser.

As also shown in FIG. 19, in order to enhance event marketing and event attendance of related events or other events provided through the on-line event management website, if not already previously accomplished, the potential attendee user is provided one or more event management website registration web page forms 47, 48 (block 171), such as, for example, those shown in 5A-5B. The event management website registration web page forms 47, 48, in combination, preferably include a plurality of potential attendee user attribute fields which function to pre-register each potential attendee user with the on-line event management website, to thereby enhance event registration for multiple events, negating the need to enter such information each time the potential attendee user wishes to register for an event. The potential attendee attributes preferably include potential attendee user location, potential attendee user specialty, and potential attendee user classification, e.g., in the medical field, physician, nurse, physical therapist, dermatologist, and others known to those skilled in the art.

In order to enhance user accountability, help prevent fraud, provide positive identification and non-anonymous access to the on-line event registration web page forms 55 from the event management website, and to reduce the number of incidents of forgotten user names often resulting in multiple registrations of the same user, the potential attendee user's e-mail address is preferably assigned (block 173) to each respective potential attendee user as that user's site access username. Further, in response to entry and submission of the pre-registration data (block 175), the attribute data for the potential attendee attributes provided by the potential attendee user in the event management website registration web page form is analyzed in order to provide selective marketing (block 177) of a plurality of events provided by the event management website.

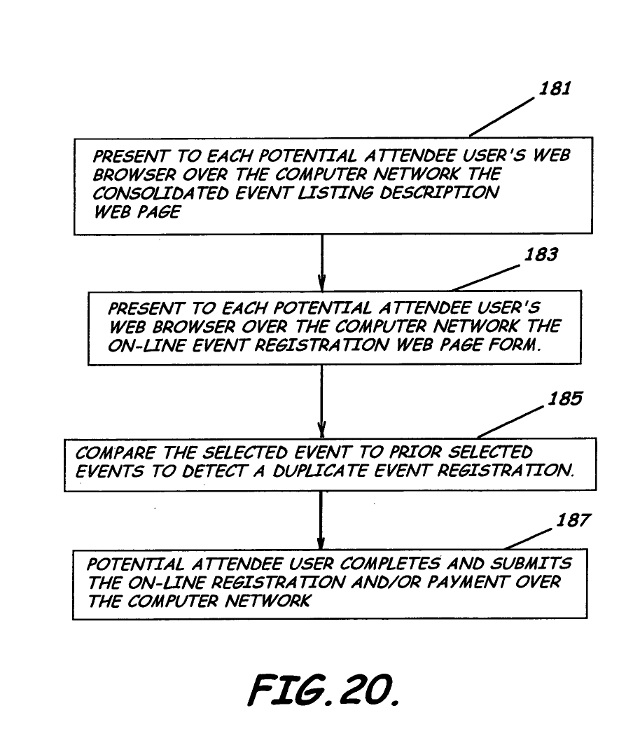

As also shown in FIG. 20, embodiments of the present invention include methods of facilitating event registration, planning, and management of events through an on-line event management website over a computer network 33 that prevent inadvertent duplicate registration for the same event. For example, such a method includes presenting (block 181) to each potential attendee user's web browser a consolidated event listing web page 53, such as that illustrated in FIG. 7, to thereby display a plurality of events to a plurality of potential attendee user. In response to selection of one of the events displayed in the consolidated event listing web page 53 or through direct access by a potential attendee user, an on-line event registration web page form 55, such as that illustrated in FIG. 8, is presented (block 183) to the potential attendee's web browser over the computer network 33. In response to selection of an event, the selected event is compared (block 185) to prior selected events preselected by the potential attendee user to thereby detect a duplicate event registration for the same event, when existing, enhancing potential attendee user satisfaction. Advantageously, according to the preferred embodiment of the present invention, this functionality can be accomplished by using a user's e-mail address as the username to help reduce incidents of duplicate user registrations. Other methodologies known to those skilled in the art, such as, for example, comparing user attribute data between different user registrations are nevertheless within the scope of the present invention.

Regardless of the methodology employed, if a duplicate registration is detected, the potential attendee user can be actively directly notified through the potential attendee user's web browser or passively notified by presenting the previously completed on-line event registration web page form 55 displaying previously entered data, a portion thereof, or the previously completed e-commerce web page form preferably displaying previously entered data. The potential attendee user then completes or updates and submits the displayed form (block 187).

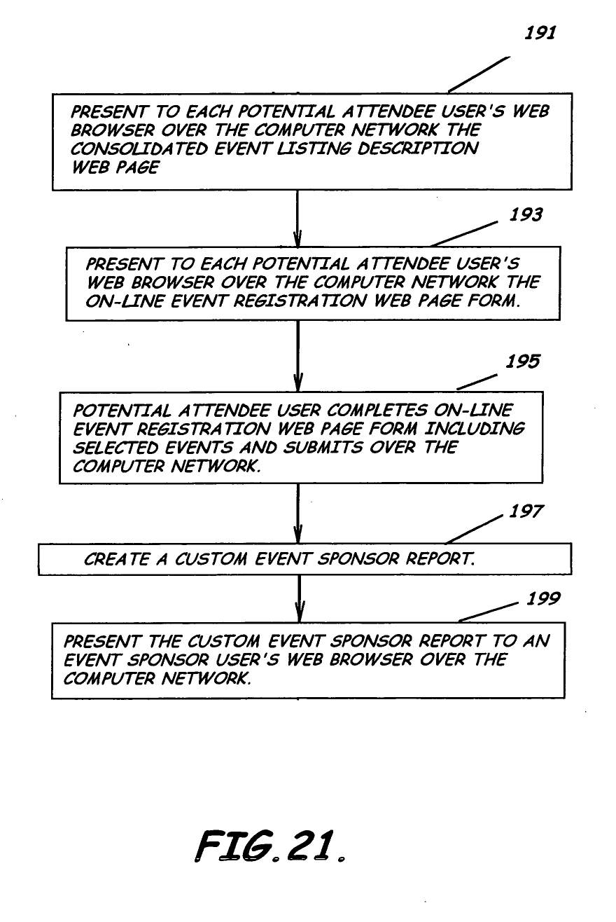

As also shown in FIG. 21, embodiments of the present invention include methods of facilitating event registration, planning, and management of events through an on-line event management website over a computer network 33 that provide custom reports to the various users. For example, according to an embodiment of the present invention, a method of providing a custom report to an event sponsor includes either first presenting (block 191) to each potential attendee user's web browser a consolidated event listing web page 53 to provide selection of one of the events or providing direct access to a preselected event in order to present (block 193) an on-line event registration web page form 55 to a potential attendee's web browser over the computer network 33. The potential attendee user completes and submits the on-line event registration web page form 55 (block 195). In response to the data included in the on-line event registration web page form 55, a custom event sponsor report (not shown) is either automatically created or created on-demand (block 197) through a query. Correspondingly, as a result of a query by the event sponsor or a request for automatic periodic updates or updates at a preselected time, a custom event sponsor report including real-time registration data is presented (block 199) to an event sponsor user's web browser over the computer network 33.

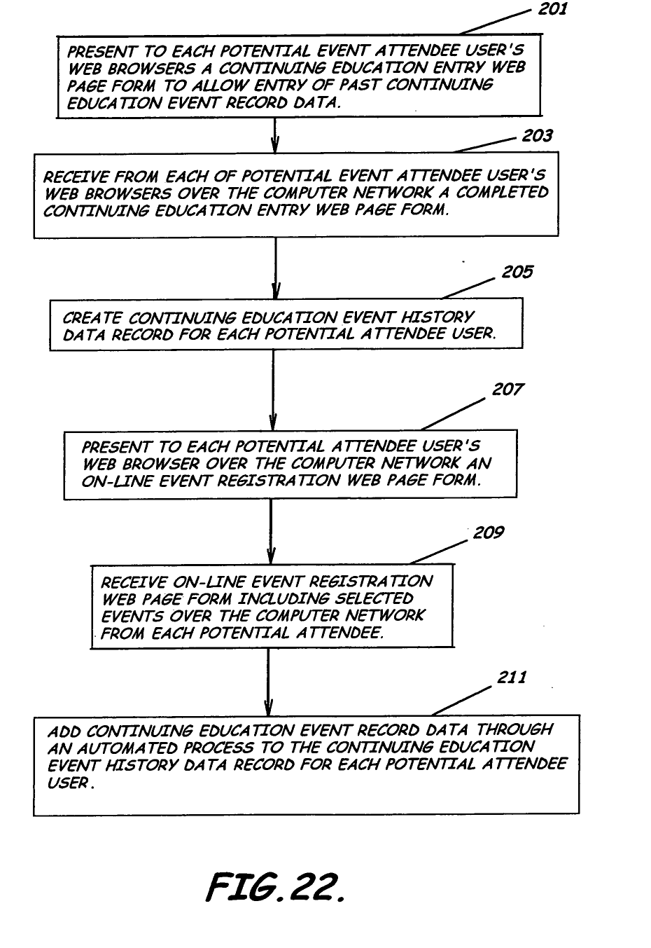

As also shown in FIG. 22, embodiments of the present invention include methods of managing continuing education through an on-line event management website over a computer network 33. For example, according to an embodiment of the present invention, a method includes presenting (block 201) over a computer network 33 to each of a plurality of potential event attendee user's web browsers for a corresponding plurality of potential event attendee users, a continuing education entry web page form 71, such as that illustrated in FIG. 14. The continuing education entry web page form 71 includes data fields that allow entry of past continuing education event record data, to thereby form a continuing education event history data record for each of the plurality of potential event attendee users and to continually maintain the event history data record by supplementing the record with courses earned through outside sources, as they are completed. After receiving (block 203) over the computer network 33 a respective completed continuing education entry web page form 71 for the respective potential attendee users, continuing education event history data records are created (block 205) for each respective potential event attendee user, and preferably stored in a database 41 associated with the on-line event management website. Note, the continuing education event history data record can be stored as a separate data record or as a portion of the each user's user data records 43 stored in the event management database 41. Further, the continuing education event history data can be stored in separate categories as necessary to allot a portion of the credits between the differing categories in order to meet regulatory or association requirements.

In response to a user selection of a continuing education event associated with the on-line event management website, an on-line event registration web page form 55 for the continuing education event is presented (block 207) to each potential event attendee's web browser over the computer network 33. Correspondingly, the user can submit over the network 33, and an event management server 35 associated with the on-line event management website can receive (block 209) over the network 33, the on-line event registration web page form 55 for each selected continuing education event. Preferably upon documentation of attendance or confirmation of completion of the selected continuing education event registered using the on-line event registration web page form 55, continuing education event record data associated with the selected continuing education event can be automatically added (block 211) to the continuing education event history data record for each respective potential attendee user.

Further, each user, upon completion of a continuing education event registered with the on-line event management website using the on-line event registration web page form 55, can receive, over the network 33, an on-line continuing education certificate (not shown) printable through a user's computer. Still further, each user having a continuing education credit history can view the history using an on-line continuing education transcript web page 73, such as that illustrated in FIG. 15. According to an embodiment of the present invention, the on-line continuing education transcript web page 73 preferably includes the categories of: total continuing education obtained for a specified period based upon the type of continuing education event, i.e., live continuing education registered through use of the on-line event management website; on-line continuing education obtained through associated on-line sources such as the on-line catalog illustrated in FIG. 17; and other continuing education credits obtained elsewhere and entered by the user and respective user's continuing education history data record.

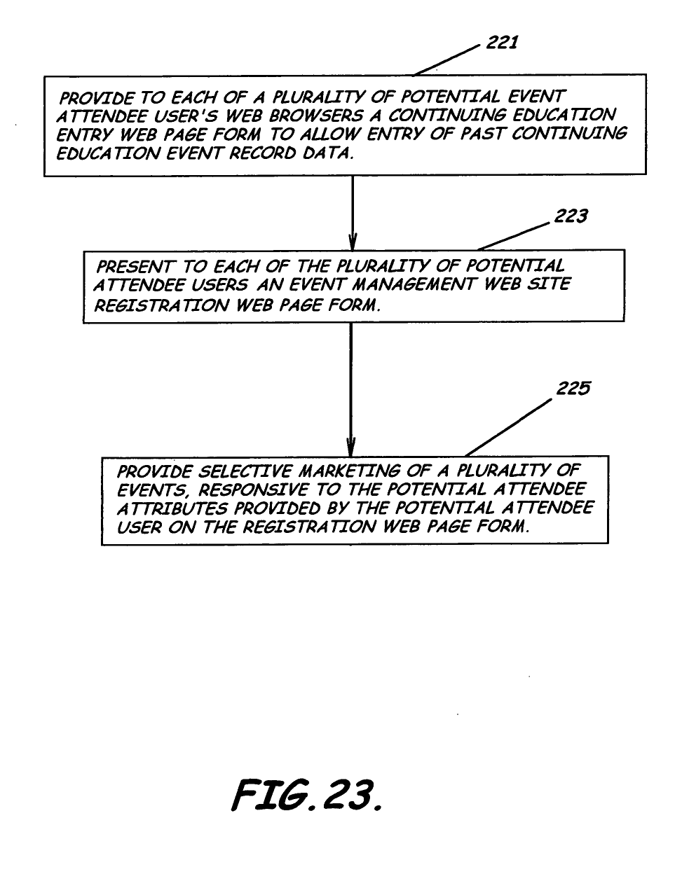

As also shown in FIG. 23, embodiments of the present invention include methods of marketing continuing education events through an on-line event management website over a computer network 33. For example, a method according to an embodiment of the present invention includes the steps of providing (block 221) over a computer network 33 to each of a plurality of potential event attendee user's web browsers for a corresponding plurality of potential event attendee users, a continuing education entry web page form 71 (see FIG. 14), to allow entry of past continuing education event record data for each of the plurality of potential event attendee users, to thereby provide a continuing education event history data record repository for each of the plurality of potential event attendee users and to continually maintain the event history data record by supplementing the record with courses earned through outside sources. Advantageously, providing such service enhances event marketing by providing an impetus to encourage on-line event management website visitations by a plurality of potential event attendees.

Further, in the preferred embodiment of the present invention, in order to form and/or obtain access to such repository of continuing education history data, each potential attendee is required to pre-register with the on-line event management website using a website registration web page form or forms 47, 48, such as those illustrated in FIGS. 5A and 5B, presented to the potential attendee user (block 123). The website registration web page forms 47, 48, can include a plurality of potential attendee user attribute fields, such as, for example: user name; user e-mail address; user location; user professional specialty; type of professional or specialist, e.g., physician, nurse, physical therapist; and other attributes known to those skilled in the art.

Advantageously, these forms 47, 48, allow for the mining of data which provide event management marketing members information useful in enhancing selective or targeted (tailored) marketing programs for events associated with the event management website. That is, using each potential attendee user's mailing and/or e-mail address and the potential attendee attributes provided by the potential attendee user in the event management website registration web page forms 47, 48, selective marketing of a plurality of events tailored to each potential attendee user can be provided (block 225), to thereby enhance overall event marketing and event attendance. Also, advantageously, by having a potential attendee user pre-registered with the on-line event management website, on-line registration for various events can be streamlined to allow for expedient registration, thus reducing the potential for a user under a severe time constraint to terminate the registration process due to a need to fill out a “lengthy” registration form in order to register for an event.

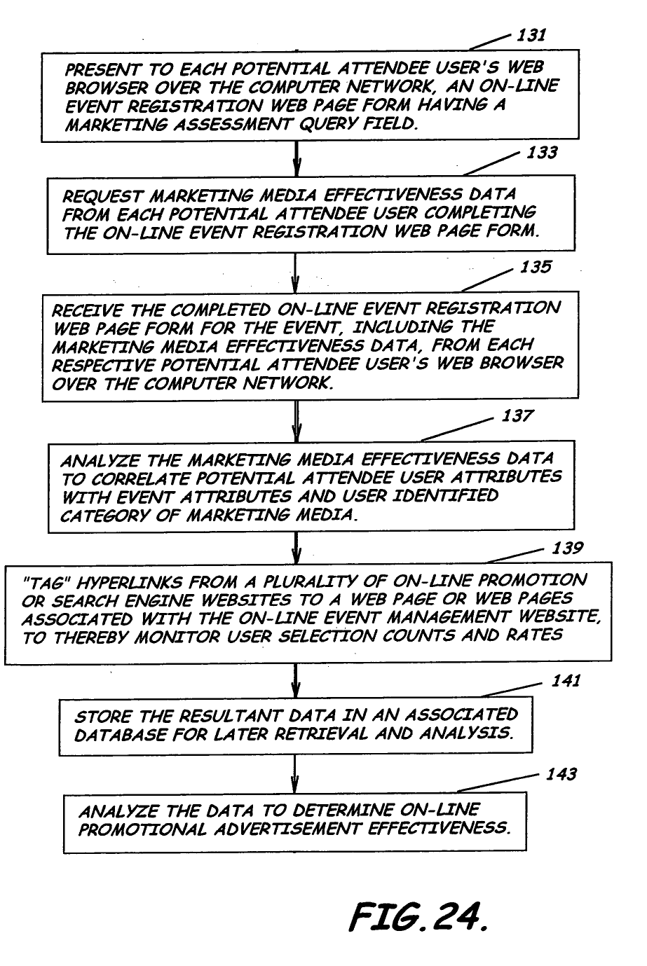

Further, as shown in FIG. 24, according to an embodiment of the present invention, the method can include presenting to each potential attendee user's web browser over the computer network 33, an on-line event registration web page form 55 (FIG. 8) having a marketing assessment query field 56 (block 131), accessed directly or through selecting an event displayed in the consolidated event listings web page 53, to request and harvest marketing media effectiveness data from each potential attendee user completing the on-line event registration web page form 55 (block 133). According to the preferred embodiment of the present invention, the marketing media effectiveness query field 56 is positioned to receive a result of a query requesting potential attendee user identification of a category of marketing media prompting the potential attendee user to register for the event. The field can be free-form but is preferably provided with preselected categories such as, for example, colleague, e-mail, mailer, representative, web, and other.

Upon receiving from each respective potential attendee user's web browser over the computer network 33, the completed on-line event registration web page form 55 including the marketing media effectiveness data (block 135), the marketing media effectiveness data can be analyzed to correlate potential attendee user attributes with event attributes and the identified category of marketing media (block 137), to thereby further provide selective marketing of a plurality of events.

Still further, the method can include harvesting marketing media effectiveness data from a plurality of on-line promotion or search engine websites, as known to those skilled in the art, by collecting information pertaining to potential attendee user selection of a hyperlink to a web page on the on-line event management website associated with a physical and/or on-line event. According to an embodiment of the present invention, this can be accomplished, preferably transparent to the potential attendee user, by “tagging” such links (block 139), storing the resultant data in an associated database for later retrieval and analysis (block 141), and analyzing the data to determine on-line promotional advertisement effectiveness (block 143).

According to an embodiment of the present invention, to further encourage visitation of the on-line event management website, on-line continuing education course events, such as those illustrated in FIG. 17, can be provided either free of charge or for a nominal fee for when the potential attendee user merely desires to audit the course due to interest in the subject matter of the course, with a more commercially desirable fee charged preferably only when the user requires a certificate for the on-line course event. That is, this business model provides for generating revenue where the potential attendee user requires the continuing education credit associated with the on-line course to satisfy a regulatory requirement. Advantageously, such resulting visitations to the on-line event management website form a marketing tool that encourages potential attendee users to be exposed to, and thus, review and register for other featured events.

It is important to note that while embodiments of the present invention have been described in the context of a fully functional system, those skilled in the art will appreciate that the mechanism of the present invention and/or aspects thereof are capable of being distributed in the form of a computer readable medium of instructions in a variety of forms for execution on a processor, processors, or the like, and that the present invention applies equally regardless of the particular type of signal bearing media used to actually carry out the distribution. Examples of computer readable media include: nonvolatile, hard-coded type media such as read only memories (ROMs) or erasable, electrically programmable read only memories (EEPROMs), recordable type media such as floppy disks, hard disk drives and CD-ROMs, and transmission type media such as digital and analog communication links.

As shown in FIGS. 1-24, embodiments of the present invention also include a computer readable medium that is readable by a computer to facilitate event registration, planning, and management of events through an on-line event management website over a computer network. For example, in an embodiment of the present invention, the computer readable medium includes a set of instructions that, when executed by the computer, such as, for example, the event management server 35, cause the computer to perform the operations of: providing to an event management member user's web browser over the computer network 33 a new-event-creation form 49, such as that illustrated in FIG. 6 or other suitable type of event-creation form. The new-event-creation form 49 illustrated in FIG. 6 or other similar type of event-creation form, having a plurality of planning event data fields preferably including among others, event time, event location, event description, and number of education credits assigned or available to the new event, can be provided not only to create a new event (new event data record 45) to be stored in an associated database 41 accessible through the on-line event management website, but also to edit a new but pre-existing event being developed. As described previously, this event editing (planning) process is typically accomplished during multiple data entry sessions often by different event management member users over multiple days spanning a period of time of up to a year or more.

Whether the event is being first initialized or in the later stages of planning, an event coordinator user or other event management member user enters or edits event data for a new event in the new-event-creation form 49. Each time the form 49 is submitted by an event management user, the event planning data is updated in the database 41. Advantageously, the new-event-creation form 49 is a web-based form provided over the network 33. This allows the form 49 to be viewed by multiple geographically separated event management member users without the need for specialized software programs to be installed on the various user's computers. Correspondingly, the data entered or selected within the new-event-creation form 49 for the new event is received from the event management member's web browser over the computer network 33 and stored in the database 41, to either initialize a new event or edit a pending new event.

Once event planning is completed, an event management member user, preferably an event administrator, releases the new event to allow event registration for the new event by a plurality of potential event attendees. Correspondingly, the computer readable medium includes instructions to perform the operation of automatically, in response to the release, extracting the event data either from the new-event-creation form 49 or an associated event data record 45 and creating an on-line event registration web page form 55 such as, for example, that illustrated in FIG. 8. The on-line event registration web page form 55 preferably includes a plurality of registration event data fields corresponding to the planning event data fields associated with the new-event-creation form 49. Where the event is an education-based or continuing education event, the registration event data fields in the on-line event registration web page form 55 preferably include user selectable event attendance and education credit options to thereby provide custom registration for each potential event attendee user.

The computer readable medium also includes instructions to perform the operation of automatically, also in response to the release, adding the event to a consolidated event listing web page 53, such as that illustrated in FIG. 7, and presenting over the computer network 33 to each of a plurality of geographically separated potential event attendees, through their respective web browsers, the consolidated event listing web page 53 displaying the new event, to thereby market the new event to the potential event attendees. Upon selection by each potential event attendee of a link to a desired event, e.g., logo or thumbnail 51 (FIG. 7), each user is presented the on-line event registration web page form 55 over the computer network 33 through the respective user's web browser. Advantageously, because of the web-based implementation, presentation of both the consolidated event listing web page 53 and the on-line event registration web page form 55 can be accomplished to multiple users substantially simultaneously.

According to an embodiment of the present invention, the computer readable medium also includes instructions to perform the operation of presenting to each potential event attendee a continuing education entry web page form 71, such as that illustrated in FIG. 14, over the computer network 33 through each potential event attendee's web browser. The continuing education entry web page form 71 preferably includes data fields that allow entry of past continuing education event record data, to thereby form a continuing education event history data record for each potential event attendee. The instructions also include those to perform the operations of: receiving over the computer network 33 a respective completed continuing education entry web page form 71 for the respective potential event attendee, and creating and storing a database 41 associated with the on-line event management website, a continuing education event history data record for each participating potential event attendee.

The instructions also include those to perform the operations of: automatically adding any continuing education credits associated with the event registered for by using the on-line event registration web page form 55 to the continuing education event history data records for each respective potential attendee user. In order to comply with various regulatory or association requirements, the addition of these credits can be withheld pending documentation of attendance or confirmation of completion of the selected continuing education event. Correspondingly, the instructions can also include those to perform the operation of receiving such confirmation of completion.

Further, in order to expedite providing each user documentation of event completion often received by various professional boards or associations, according to an embodiment of the present invention, the instructions include those to perform the operation of providing each user, over the network 33 through the users web browser, an on-line continuing education certificate (not shown) printable by a user's computer. Still further, the instructions can include those to perform the operation of presenting to each user having a continuing education credit history, and an on-line continuing education transcript web page 73, such as that illustrated in FIG. 15. According to an embodiment of the present invention, the on-line continuing education transcript web page 73 preferably includes the categories of: total continuing education obtained for a specified period based upon the type of continuing education event, i.e., live continuing education registered through use of the on-line event management website; on-line continuing education obtained through associated on-line sources, such as the on-line catalog illustrated in FIG. 17; and other continuing education credits obtained elsewhere and entered by the respective user's continuing education history data record. These categories can be further subdivided by type of association category, e.g. AMA, AAFP, for medical professionals.

According to an embodiment of the present invention, the computer readable medium also includes instructions to perform the operation of providing to each potential event attendee through their respective web browser, an on-line catalog, such as that illustrated in FIG. 17, and an on-line course completion certificate, in response to course completion and preferably on-line payment, as described previously. Further, according to an embodiment of the present invention, in response to selection of an on-line course listed in the on-line catalog, presented is an on-line course registration web page (not shown) preferably including education credit options to allow the user to apply, as desired, any available continuing education credit, associated with the on-line course, to the users continuing education credit history.

This application is related to U.S. Provisional Application No. 60/683,594 filed on May 23, 2005, incorporated herein by reference in its entirety.

In the drawings and specification, there have been disclosed a typical preferred embodiment of the invention, and although specific terms are employed, the terms are used in a descriptive sense only and not for purposes of limitation, the scope of the invention being set forth in the following claims. The invention has been described in considerable detail with specific reference to these illustrated embodiments. It will be apparent, however, that various modifications and changes can be made within the spirit and scope of the invention as described in the foregoing specification.

That claimed is:

1. An event management system to facilitate event registration, planning, promotion, and management of continuing education events through an on-line event management website over a computer network, the system comprising:
at least one host computer hosting the online event management website accessible to the computer network to define an event management server, the event management server having a processor and memory coupled to the processor to store operating instructions therein;
a database accessible to the processor of the event management server and including user data records and event data records related to a plurality of continuing education events, the user data records including user attribute data, the event data records including an event time, event location, event description, and event sponsor for each of the plurality of continuing education events;
an event management program product stored in the memory of the event management server to facilitate event registration, planning, and management of continuing education events over the computer network, the event management program product including:
an event planner positioned to provide to an event management member user's web browser a new-event-creation web page form having a plurality of database input fields and positioned to perform, responsive to data entered by an event management member user, the operations of adding a new event data record to the database and editing a pending new event data record stored in the database,
a people manager positioned to provide to a potential attendee user's web browser an event management website registration web page form including a plurality of potential attendee user attribute data fields and positioned to perform, responsive to data entered by the potential attendee user, the operation of storing in the database user data records including the user attribute data,
an event registrar positioned to access the user data records and the event data records in the database, positioned to provide to a potential attendee user's web browser an event registration web page form to register for a user selected event, and positioned to perform, responsive to initiating registration for the selected event, the operation of associating the potential attendee user to the selected event,
an entry initiator positioned to access the user data records in the database to thereby provide user login access for and authentication of a user to allow entry of and access to data stored in the database,
an administrator positioned to access the user data records in the database to thereby determine user permission levels and to restrict access to data in the database, and
an event information reporter positioned to access the event data records in the database to thereby produce reports related to events selected by a user, the reports formatted to be viewed over the network by the user's web browser;
a plurality of event management member user's computers each positioned remote from the event management server and accessible to the computer network and having a processor, memory coupled to the processor to store operating instructions therein and to receive database records, a display in communication with the processor to display data records using an associated event management member user's web browser, and a user interface in communication with the processor, to provide each of a corresponding plurality of event management member users with on-line web-based access over the computer network to the event data records to thereby view and edit event data; and
a plurality of potential attendee user's computers each positioned at a respective plurality of potential attendee user sites remote from the event management server and accessible to the computer network and having a processor and memory coupled to the processor to store operating instructions therein and to receive database records, a display in communication with the processor to display data records using an associated potential attendee user's web browser, and a user interface in communication with the processor to provide the potential attendee user with on-line web-based access to user data records over the computer network to thereby view and edit user data and to provide access to event data records over the computer network to thereby view event data to register for at least one scheduled event.

2. A system as defined in claim 1,
wherein the plurality of event management member user's computers include at least one event coordinator user's computer positioned remote from the event management server and accessible to the computer network and having a processor, memory coupled to the processor to store operating instructions therein and to receive database records, a display coupled to the processor to display new-event-creation web page forms using an event coordinator user's web browser, and a user interface coupled to the processor to provide the event coordinator user with on-line web-based access to event data records over the computer network, to thereby add new event records to the database and edit pending new event data records stored in the database using the new-event-creation web page forms.

3. A system as defined in claim 2, the system further comprising:
at least one event sponsor user's computer positioned at an event sponsor user site remote from the event management server and accessible to the computer network and having a processor, memory coupled to the processor to store operating instructions therein and to receive database records, and a display coupled to the processor to display database records using an event sponsor user's web browser and a user interface coupled to the processor to provide an event sponsor user with on-line web-based access to event data records over the computer network to thereby allow the respective events sponsor to review real-time event registration and attendance levels for the new event.

4. A system as defined in claim 2, the system further comprising:
at least one event director user computer positioned at an event director user site remote from the event management server and accessible to the computer network and having a processor, memory coupled to the processor to store operating instructions therein and to receive database records, and a display coupled to the processor to display database records using an event director user's web browser and a user interface coupled to the processor to provide an event director user with on-line web-based access to event data records over the computer network to thereby allow the respective event director user to review real-time event registration and attendance levels for the new event.

5. A system as defined in claim 2,
wherein the event register is positioned to perform the operation of providing an e-commerce web page form to the plurality of potential attendee users through each respective potential attendee user's web browser, to provide each potential attendee user real-time self-registration and to provide each potential attendee user on-line payment options including on-line check and on-line credit card payment options, to thereby provide the event coordinator user for the respective event with substantially real-time registration data to enhance event planning and evaluation;
wherein each event data record includes an event account record; and
wherein the event management program product further comprises a payment register positioned to perform the operations of receiving for each event from an event management member user a payment item description and a payment amount, associating each payment item description and payment amount with a respective event account record, and accessing event data records, responsive to registration of the potential attendee user, to associate an event registration payment transaction with the event account record for the respective event data record.

6. A system as defined in claim 1,
wherein the plurality of potential attendee users are a plurality of continuing education event attendee users; and
wherein the entry initiator provides each continuing education event attendee direct access to the database to view substantially real-time continuing education credit transcript data and to print a continuing education certificate of completion for a prior attended online registered event, to thereby enhance user satisfaction.

7. A system as defined in claim 1, wherein the event management website includes an events listing web page to provide user review and selection of registrable events and a user current-registration web page to provide each of the plurality of attendee users a respective list of prior registered events, negating a need to directly contact event management members for such event data, and includes event-creation web page forms viewable by the plurality of event management member users to provide real-time event development data, to thereby provide a single location for substantially all available event data in the event management system, reducing event management overhead.

8. A system as defined in claim 1,
wherein users are classified as at least three of the following: potential event attendees, event speakers, event sponsors, event coordinators, event directors, and event management members; and
wherein the administrator provides a separate permission level to the each respective user, responsive to the user classification.

9. An event management system to facilitate event registration, planning, promotion, and management of events through an on-line event management website over a computer network, the system comprising:
at least one host computer hosting the online event management website accessible to the computer network to define an event management server, the event management server having a processor and memory coupled to the processor to store operating instructions therein;
a database accessible to the processor of the event management server and including user data records and event data records related to a plurality of events, the user data records including user attribute data, the event data records including an event time, event location, event description, and event sponsor for each of the plurality of events;
a plurality of event management member user's computers each positioned remote from the event management server and accessible to the computer network and having a processor, memory coupled to the processor to store operating instructions therein and to receive database records, a display in communication with the processor to display data records using an associated event management member user's web browser, and a user interface in communication with the processor, to provide each of a corresponding plurality of event management member users with on-line web-based access over the computer network to the event data records to thereby view and edit event data; and
an event management program product comprising a set of machine-readable instructions stored in the memory of the event management server to facilitate event registration, planning, and management of events over the computer network, the event management program product including instructions to perform the operations of providing each of the plurality of event management member users over the computer network concurrent access to event data records for a plurality of events through each event management member user's web browser, creating an on-line event registration web page form for each event for registering users to the events, and providing event management member users, event director users, and event sponsor users over the computer network through each respective user's web browser custom web-based reports for at least one selected event.

10. A system as defined in claim 9,
wherein the events are continuing education events providing potential event attendees continuing education credit;
wherein the system further comprises a plurality of potential attendee user's computers each positioned at a respective plurality of potential attendee user sites remote from the event management server and accessible to the computer network and having a processor and memory coupled to the processor to store operating instructions therein and to receive database records, a display in communication with the processor to display data records using an associated potential attendee user's web browser, and a user interface in communication with the processor to provide the potential attendee user with on-line web-based access to user data records over the computer network to thereby view and edit user data and to provide access to event data records over the computer network to thereby view event data to register for at least one scheduled event; and
wherein the event management program product further comprises instructions to perform the operations of providing to each of the plurality of potential event attendee user's web browsers a continuing education entry web page form to allow entry of past continuing education event record data, storing record data entered in the continuing education entry web page form in a continuing education event history record, to thereby provide a continuing education event history data record repository for each of the plurality of potential event attendee users, receiving from each potential event attendee user a completed on-line event registration web page form for at least one event, and adding continuing education event record data to the continuing education event history data record for each respective potential event attendee user, responsive to confirmation of completion of the at least one event.

11. A method of facilitating event registration, planning, promotion, and management of events through an on-line event management website over a computer network, the method comprising the steps of:
presenting to an event management member user's web browser over the computer network a new-event-creation form to form a new event, the new-event-creation form having a plurality of planning event data fields including event time, event location, event description, and number of education credits assigned to the new event;
entering event data for a new event in the new-event-creation form;
receiving a completed new-event-creation form for the new event from the event management member's web browser over the computer network;
storing the new event in a database accessible through the on-line event management website;
releasing the new event by the event management member user to allow event registration for the new event by a plurality of potential attendees;
creating an on-line event registration web page form, responsive to entry and release of the new event, the on-line event registration web page form including a plurality of registration event data fields corresponding to the planning event data fields associated with the new-event-creation form;
adding the new event to a consolidated event listing web page, responsive to release of the new event by the event management member user, to thereby display the new event to the plurality of potential attendee users;
presenting to each potential attendee user's web browser over the computer network the consolidated event listing web page displaying the new event; and
presenting to each potential attendee user's web browser over the computer network the on-line event registration web page form, responsive to selection of the new event on the consolidated event listing web page by each respective potential attendee user.

12. A method as defined in claim 11,
wherein the events associated with the on-line event management website are continuing education events; and
wherein the step of creating an on-line event registration web page form includes providing registration event data fields in the on-line event registration web page form having user selectable event attendance and education credit options to thereby provide custom registration for each of the plurality of potential attendee users.

13. A method as defined in claim 11, the method further comprising the steps of:
presenting to each of the plurality of potential attendee users an event management website registration web page form including a plurality of potential attendee user attribute fields to pre-register each potential attendee user with the on-line event management website to thereby enhance event registration, the potential attendee attributes including potential attendee user location, potential attendee user specialty, and potential attendee user classification; and
providing selective marketing of a plurality of events, responsive to the potential attendee attributes provided by the potential attendee user in the event management website registration web page form, to thereby enhance event marketing and event attendance.

14. A method as defined in claim 11, the method further comprising the steps of:
presenting to each of the plurality of potential attendee users an event management website registration web page form including a plurality of potential attendee user attribute fields to pre-register each potential attendee user with the on-line event management website to thereby enhance event registration; and
assigning as a username for each of the plurality of potential attendee users a respective e-mail address of each potential attendee user to provide positive identification of each potential attendee user to thereby provide non-anonymous access to on-line event registration web page forms from the event management website.

15. A method as defined in claim 11, the method further comprising the steps of:
receiving from each potential attendee user's web browser over the computer network a completed on-line event registration web page form for a selected event; and
comparing the selected event to prior selected events preselected by the potential attendee user, responsive to receiving the completed on-line event registration web page form, to thereby detect a duplicate event registration for the same event by the respective potential attendee user, when existing, enhancing potential attendee user satisfaction.

16. A method as defined in claim 11, the method further comprising the steps of:
receiving over the computer network a completed on-line event registration web page form for the new event from each potential attendee user's web browser;
creating a custom event sponsor report, responsive to receiving the completed on-line event registration web page forms; and
presenting the custom event sponsor report to an event sponsor user's web browser over the computer network, responsive to a query by the event sponsor, the event sponsor report including real-time registration data for the new event.

17. A method as defined in claim 11, wherein the events associated with the on-line event management website are continuing education events, the method further comprising the steps of:
presenting to each potential attendee user's web browser over the computer network a continuing education entry web page form to enter past continuing education event record data, to thereby form a continuing education event history data record for each of the plurality of potential attendee users;
receiving from each potential attendees user's web browser over the computer network a completed continuing education entry web page form for the respective potential attendee user;
creating the continuing education event history data record for each potential attendee user; and
periodically adding continuing education event record data to the continuing education event history data record for each potential attendee user, responsive to confirmation of completion by each respective potential attendee user of a continuing education event registered using the on-line event registration web page form.

18. A method of facilitating event registration of continuing education events through an on-line event management website over a computer network, the method comprising the steps of:
presenting to a potential attendee user's web browser a consolidated event listing web page to thereby display a plurality of events to a potential attendee user;
comparing an event selected by a potential attendee user to prior selected events preselected by the potential attendee user, responsive to selection of an event by the potential attendee user, to thereby detect an attempted duplicate event registration for the same event, when existing, enhancing potential attendee user satisfaction.
presenting to the potential attendee user's web browser over the computer network an on-line event registration or payment web page form having data fields including potential attendee user pre-entered data, responsive to detecting an attempted duplicate registration for the same event; and
receiving from the potential attendee user's web browser over the computer network a completed on-line event registration or payment web page form for the selected event.

19. A method of facilitating event registration, planning, promotion, and management of events through an on-line event management website over a computer network, the method comprising the steps of:
presenting to each potential attendee user's web browser associated with a plurality of potential attendee users over the computer network a consolidated event listings web page to thereby display a plurality of user-selectable events to each potential attendee user;
presenting to each potential attendee user's web browser over the computer network, responsive to selection of an event displayed in the consolidated event listings web page, an on-line event registration web page form;
creating a custom event sponsor report, responsive to receiving the completed on-line event registration web page forms; and
presenting the custom event sponsor report to an event sponsor user's web browser over the computer network, responsive to a query by the event sponsor, the event sponsor report including predetermined real-time registration data for the new event.

20. A method of managing continuing education through an on-line event management website over a computer network, the method comprising the steps of:
presenting to each of a plurality of potential event attendee user's web browsers over the computer network a continuing education entry web page form to allow entry of past continuing education event record data for a corresponding plurality of potential event attendee users, to thereby form a continuing education event history data record for each of the plurality of potential event attendee users;
receiving from each of the plurality of potential event attendee user's web browsers over the computer network a respective completed continuing education entry web page form for the respective potential attendee user;
creating continuing education event history data records for each of the plurality of potential event attendee users;
presenting to each potential event attendee's web browser over the computer network, responsive to selection of an on-line registrable continuing education event, an on-line event registration web page form for the continuing education event;
receiving from each respective potential attendee user's web browser over the computer network the completed on-line event registration web page form for the selected continuing education event; and
adding continuing education event record data to the continuing education event history data record for each respective potential attendee user, responsive to confirmation of completion of the selected continuing education event registered using the on-line event registration web page form.

21. A method of marketing continuing education events through an on-line event management website over a computer network, the method comprising the steps of:
providing to each of a plurality of potential event attendee user's web browsers for a corresponding plurality of potential event attendee users a continuing education entry web page form to allow entry of past continuing education event record data, to thereby provide a continuing education event history data record repository for each of the plurality of potential event attendee users;
presenting to each of the plurality of potential attendee users an event management website registration web page form including a plurality of potential attendee user attribute fields to pre-register each potential attendee user with the on-line event management website to thereby enhance ease of event registration, the potential attendee attributes including potential attendee user location and potential attendee user e-mail address, completion of the event management website registration web page form a prerequisite to providing the continuing education event history data record repository; and
providing selective marketing of a plurality of events, responsive to the potential attendee attributes provided by the potential attendee user in the event management website registration web page form, to thereby enhance event marketing and event attendance.

22. A method as defined in claim 21, the method further comprising the steps of:
presenting to each potential attendee user's web browser associated with a plurality of potential attendee users over the computer network a consolidated event listings web page to thereby display a plurality of user-selectable events to each potential attendee user;
presenting to each potential attendee user's web browser over the computer network, responsive to selection of an event displayed in the consolidated event listings web page, an on-line event registration web page form having a marketing assessment query field to harvest marketing media effectiveness data from each potential attendee user completing the on-line event registration web page form, the marketing media effectiveness query field positioned to receive a result of a query requesting potential attendee user identification of a category of marketing media prompting the potential attendee user to register for the event;
receiving from each respective potential attendee user's web browser over the computer network the completed on-line event registration web page form for the event including the marketing media effectiveness data; and
analyzing the marketing media effectiveness data to correlate potential attendee user attributes with event attributes and the identified category of marketing media, to thereby further provide enhanced selective marketing of the plurality of events.

23. A method as defined in claim 22, the method further comprising the step of:
receiving potential attendee user selection data for a plurality of hyperlinks from a corresponding plurality of on-line promotion websites to a web page associated with the on-line event management website;
storing the resultant data in a database associated with the on-line event management website for on-demand retrieval and analysis; and
analyzing the data to determine on-line promotional advertisement effectiveness, to thereby further provide enhanced selective marketing of the plurality of events.

24. A computer readable medium that is readable by a computer to facilitate event registration, planning, and management of events through an on-line event management website over a computer network, the computer readable medium comprising a set of instructions that, when executed by the computer, cause the computer to perform the following operations:
providing to an event management member user's web browser over the computer network a new-event-creation web page form having a plurality of database input fields, the event management member user's web browser accessible by an event management member user;
adding a new event data record to a database associated with the on-line event management website, responsive to data entered in the new-event-creation web page form by the event management member user;
creating an on-line event registration web page form, responsive to release of the new event by the event management member user, the on-line event registration web page form including a plurality of registration event data fields corresponding to the planning event data fields associated with the new-event-creation form;
adding the new event to a consolidated event listing web page, responsive to release of the new event by the event management member user, to thereby display the new event to a plurality of potential attendee users; and
presenting substantially simultaneously to a plurality of potential attendee user's web browsers associated with a corresponding plurality of separate and spaced apart potential attendee user's computers over the computer network, the consolidated event listing web page displaying the new event.

25. A computer readable medium as defined in claim 24, further comprising a set of instructions that, when executed by the computer, cause the computer to perform the following operation:
presenting substantially simultaneously over the computer network to each of the plurality of potential attendee user's computers through their respective potential attendee user's web browser, responsive to selection of the new event on the consolidated event listing web page by each respective potential attendee user, the on-line event registration web page form for the new event.

26. A computer readable medium as defined in claim 25, further comprising a set of instructions that, when executed by the computer, cause the computer to perform the following operation:
receiving from each respective potential attendee user's web browser over the computer network the completed on-line event registration web page form for the new event; and
adding continuing education event record data to a continuing education event history data record for each respective potential attendee user, responsive to confirmation of completion of the new event registered using the on-line event registration web page form.
